(19) United States
(12) Patent Application Publication
(10) Pub. No.: US 2008/0059563 A1
(43) Pub. Date: Mar. 6, 2008

(54) Methods and Systems for Automated Data Processing

(75) Inventors: Matt Bachmann, Allston, MA (US); Richard Boccuzzi, Ashland, MA (US); Theodore Czotter, Holliston, MA (US); Brett Rosen, Stoughton, MA (US); Jeremy Warren, Washington, DC (US)

Correspondence Address: MINTZ LEVIN COHN FERRIS GLOVSKY & POPEO, 666 THIRD AVENUE, NEW YORK, NY, 10017, US

(73) Assignee: Lavastorm Technologies, Inc., Boston, MA (US)

(21) Appl. No.: 10/577,786

(22) PCT Filed: Oct. 29, 2004
(86) PCT No.: PCT/US04/38086

§ 371 Date: Aug. 15, 2007

(30) Foreign Application Priority Data
Oct. 30, 2003 (US) 60516483

(51) Int. Cl. G06F 15/16

(52) U.S. Cl. 709/203

(57) ABSTRACT

Embodiments of the present invention are directed to methods and systems for processing and/or validating data using a graphical user interface of a computer system. Embodiments may include arranging a plurality of nodes in a graph, where each node represents at least one processing step for processing data by a processor and wherein at least one of the plurality of nodes comprise at least one data retrieval node for retrieving data for validation. The method may also include establishing at least one output from substantially all of the plurality of nodes, except for the at least one data retrieval node, establishing at least one input to each of the plurality of nodes, configuring one or more parameters of each node, and linking at least one output of each of substantially all of the plurality of nodes to an input of another node, where each link representing a data flow. The method may further include sequencing a dependency among the plurality of nodes and establishing processing logic in at least one node to process data in a predetermined manner.

### FIELD OF THE INVENTION

Embodiments of the present invention are related to methods and systems for processing and/or validating data, and more particularly, to methods and systems for validating data for revenue assurance.

### BACKGROUND OF THE INVENTION

In many organizations data validation, whether for revenue assurance or any other purpose, is a difficult and error-prone task. For a wide array of reasons, business rules and/or logic used to validate data are often so complex that their implementation is manually intensive, resulting in tremendous inefficiencies of time and cost, as well as many possible human errors (e.g., typos). While these issues are quite common and well known, too many organizations continue to do revenue assurance without automated processes.

In the past, where an automated or partly automated solution has been attempted, it has most often taken the form of scripts. SQL, shell, and other scripts comprise the vast majority of information technology (IT) leveraged revenue assurance solutions. Yet scripts and other obtuse programs create problems of their own, mostly stemming from the fact that scripts are difficult to read and/or understand. Moreover, since scripts provide virtually no means for complexity management, they often develop into tangled and complicated programs. As a result, scripts usually can only be modified (if at all) by the person who originally wrote them. However, even if they can be modified, every modification carries with it the risk of breaking the entire script. Even additive changes risk altering preexisting functionality. In addition, since typically only the programmer understands the scripts, a subject matter expert, i.e., one who understands the processing/validation rules to be applied, cannot easily determine whether a script is drafted correctly. Thus, the creation of a correct script is difficult, time consuming and costly.

For example, since business rule requirements in current data validation methods must be documented with painstaking detail to mitigate communication risks, development moves slowly along with little regard for deadlines and testing must be methodical and lengthy. When scripts are completed, the business rules incorporated in the script most likely have changed. This lag is the fundamental failure of script-based solutions which results in inaccuracy of results, thus diminishing their value.

### SUMMARY OF THE INVENTION

Embodiments of the invention address problems of prior art data processing/validation techniques and present novel systems and associated processes, which enable an iterative, collaborative process for implementing business rules and other logic (together rules) to process and/or validate data. Data processing may be defined, executed, analyzed and refined in minutes, and may be repeated until the rules are both precise and accurate, taking hours or days instead of months. The rules themselves are easily codified in visual flowcharts that are easy to read and understand by even non-technical personnel.

Moreover, embodiments of the present invention inherently provide a basic level of documentation with no extra effort. For example, documentation may easily be effected using an HTML document with a complete audit trail of the last execution of a business rule graph, including all nodes, connections, parameters (fields), embedded source code, notes, statistics, execution times and duration, excerpts of data, and the like.

In effect, some embodiments of the invention allow a user to program a computer using a graphical user interface to draft a visual and working flowchart for data processing using a plurality of predefined nodes, each of which accomplish predefined and modifiable tasks.

In one embodiment of the present invention, a method for processing data using a graphical user interface of a computer system is provided and may include arranging a plurality of nodes in a graph, where each node represents at least one processing step for processing data by a processor and wherein at least one of the plurality of nodes comprise at least one data retrieval node for retrieving data for validation. The method may also include establishing at least one output from substantially all of the plurality of nodes, except for the at least one data retrieval node, establishing at least one input to each of the plurality of nodes, configuring one or more parameters of each node, and linking at least one output of each of substantially all of the plurality of nodes to an input of another node, where each link representing a data flow. The method may further include sequencing a dependency among the plurality of nodes and establishing processing logic in at least one node to process data in a predetermined manner.

In another embodiment of the invention, a system for processing data using a graphical user interface of a computer system is provided and may include arranging means for arranging a plurality of nodes in a graph-space, where each node represents at least one processing step for processing data and wherein at least one of the plurality of nodes comprise at least one data retrieval node for retrieving data for validation. The system may also include establishing means for establishing at least one output from substantially all of the plurality of nodes and for establishing at least one input to each of the plurality of nodes, except for the at least one data retrieval node, configuring means for configuring one or more parameters of each node, and linking means for linking at least one output of each of substantially all of the plurality of nodes with an input of another node, where each link representing a data flow. The system may also include sequencing means for sequencing execution of one or more nodes and setup means for setting up processing logic in at least one node to process data in a predetermined manner.

In yet another embodiment of the invention, a system for processing data using a graphical user interface of a computer system is provided and may include an editor including a graphical user interface, a graphical workspace for designing a processing graph having a plurality of processing nodes, an execution file, where the execution file results from compiling the processing graph and a controller for directing the running of the execution file on one or more computers.

Further embodiments may also include computer readable media having computer instructions for enabling a computer system to perform methods according to any of the embodiments of the invention. Other embodiments may include application programs for enabling a computer system to perform the methods according to any of the embodiments of the invention.

These and other embodiments, as well as further objects and advantages of the present invention will become even more clear with reference to the following detailed description and attached figures, a brief description of which follows.

### BRIEF DESCRIPTION OF THE FIGURES

FIG. 1 illustrates a block diagram of a system for processing and/or validating data according to an embodiment of the invention.

FIG. 2 illustrates a workflow for BRAIN for processing and/or validating data according to an embodiment of the invention.

FIG. 3 illustrates a screenshot of a graphical-user-interface (GUI) for use with an editor program for graphically programming a data processing and/or validation process according to an embodiment of the invention.

FIG. 4 illustrates a representative example of a graphical program/process, having a plurality of interconnected nodes for accomplishing a data processing/validation process.

FIG. 5 illustrates a timing (clock) node for sequencing nodes of a graphical program according to an embodiment of the invention.

FIG. 6 illustrates a parameter popup window for an editor program for editing parameters of an example node according to an embodiment of the invention.

FIG. 7 illustrates a bundler node according to an embodiment of the present invention.

FIG. 8 illustrates a composite node according to an embodiment of the present invention.

FIG. 9 illustrates an example of a beginning stage of a development of a business rule graph according to an embodiment of the invention.

FIG. 10 illustrates a parameter popup window for a type of data retrieval node node according to an embodiment of the present invention.

FIG. 11 illustrates a parameter popup window for another type of data retrieval node according to an embodiment of the present invention.

FIG. 11 illustrates a parameter popup window for determining outputs of a node according to an embodiment of the present invention.

FIG. 13 illustrates an example of a further stage of a development of a business rule graph according to an embodiment of the invention.

FIG. 14 illustrates a parameter popup window for a concatenating node according to an embodiment of the present invention.

FIG. 15 illustrates an example of yet a further stage of a development of a business rule graph according to an embodiment of the invention.

FIGS. 16A-16C illustrate popup windows displays of results of processed data for a node according to an embodiment of the present invention.

FIG. 17 illustrates an example of still yet a further stage of a development of a business rule graph according to an embodiment of the invention.

FIG. 18 illustrates a parameter popup window for a sorting node according to an embodiment of the present invention.

FIG. 19 illustrates an example of still yet a further stage of a development of a business rule graph according to an embodiment of the invention.

FIG. 20 illustrates a popup up window display for indicating join types of a join node according to an embodiment of the invention.

FIG. 21 is a Venn diagram illustrating what data is sent to a particular output of a join node according to an embodiment of the invention.

FIG. 22 illustrates a parameter window for indicating the scripting language for the join.

FIG. 23 illustrates an example of still yet a further stage of a development of a business rule graph according to an embodiment of the invention.

FIG. 24 illustrates an example of still yet a further stage of a development of a business rule graph according to an embodiment of the invention.

FIG. 25 illustrates a parameter popup window for a aggregating node according to an embodiment of the present invention.

FIG. 26 illustrates an example of a completed initial development of a business rule graph according to an embodiment of the invention.

FIG. 27 illustrates a parameter popup window for a database loading node according to an embodiment of the present invention.

### DETAILED DESCRIPTION OF THE EMBODIMENTS

Embodiments of the present invention may be embodied in hardware (e.g., ASIC, processors and/or other integrated circuits), or software, or both. For illustrative purposes only, the embodiments of the invention will be described as being embodied in software operating on one or more computer systems, and preferably, operated over a computer network. Such a network may include one or more server computers and one or more workstation computers (a workstation may also operate as a server).

In the detailed description which follows, embodiments of the invention will sometimes be described with reference to processing and/or validating data with respect to a telecommunications system. Such descriptions are meant as an example only and are not intended to limit the scope of the invention.

### BRAIN

Embodiments of the present invention include a Business Rule Automation infrastructure (BRAIN) which combines powerful complexity management for processing data with an ability to use multiple processors (e.g., one or more) from a plurality of server computers (servers) in a scalable format. Embodiments of BRAIN may include one or more of the following components: a business rule editor (BRE), a business rule graph (BRG), a business rule executable (BRX), a controller and a server farm operating one or more drones (a process for executing a task).

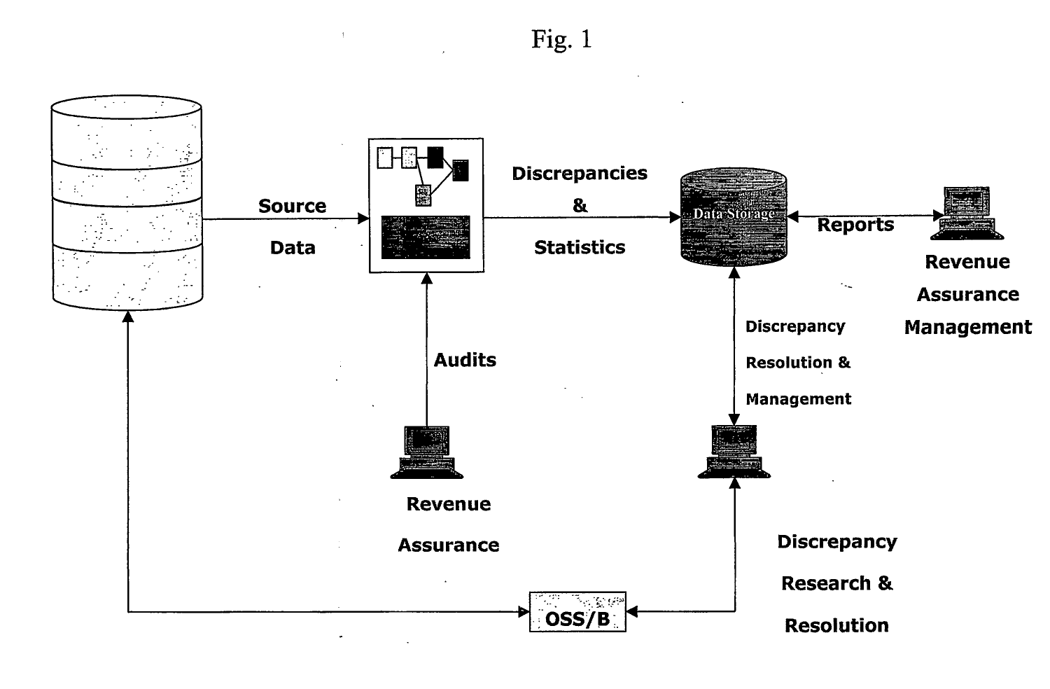

BRAIN may be operated as part of a total system for processing and/or validating data. Such a system is illustrated in FIG. 1. An example of such a system may be a revenue assurance system as disclosed in related pending U.S. patent application Ser. No. 10/356,254, filed Jan. 31, 2003 (publication no. 20040153382), the entire disclosure of which is incorporated by reference in the present application.

As shown in FIG. 1, BRAIN receives source data from a data warehouse. Such data, for a telecommunications system, may include operational support system data (OSS), business support system data (BSS) and reference data (for example). Using a workstation, an end user (user) can use BRAIN to process and/or validate the source data to generate discrepancies and statistics, which may be stored in a database (e.g., “Data Storage”). The discrepancies may be researched and resolved by a user using the same or another workstation. In addition, a user can generate reports of the discrepancies and statistics (Revenue Assurance Management). It is understood that all interaction with BRAIN and/or the entire system illustrated in FIG. 1 may be accomplished using a single workstation. FIG. 1 merely illustrates one particular manner in which the system may be arranged for multiple users and/or locations using a networked environment and multiple workstations.

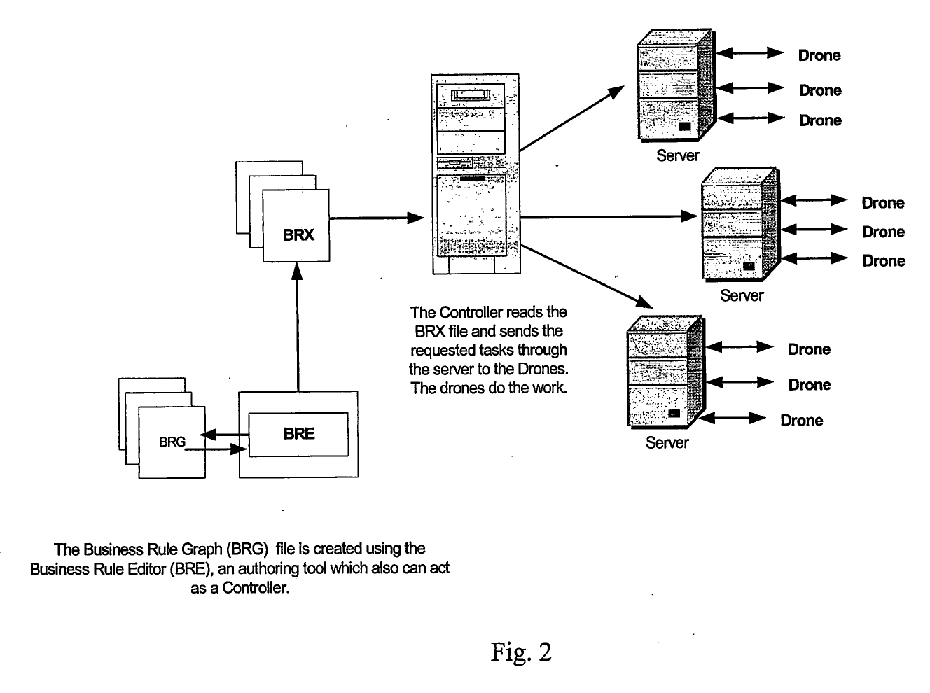

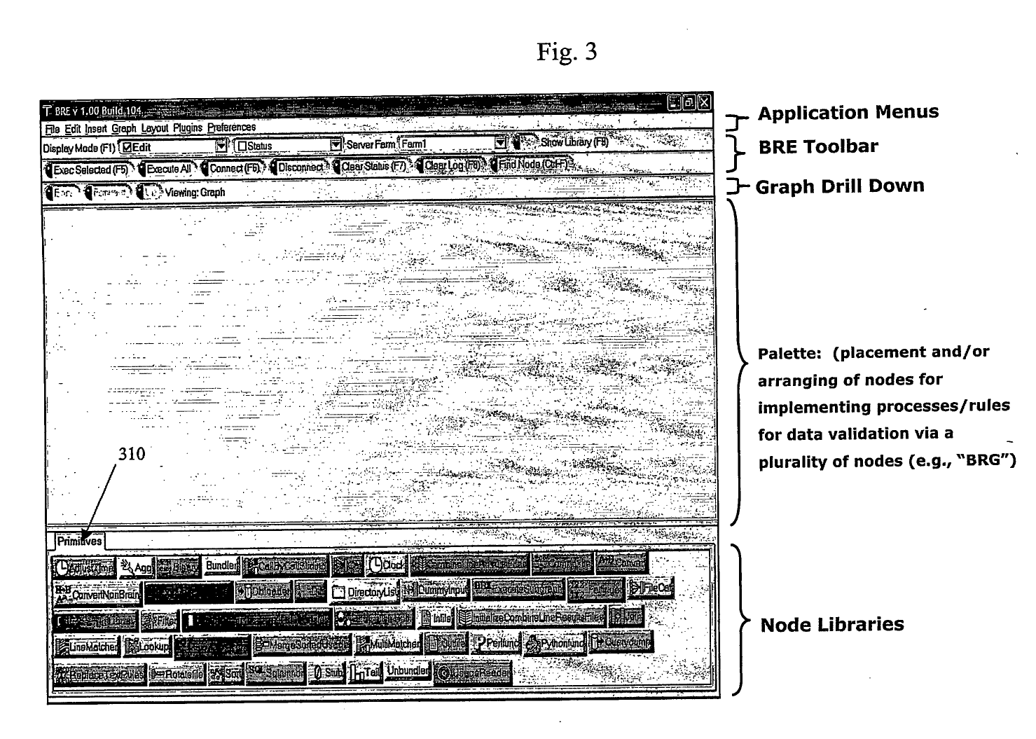

FIG. 2 illustrates a workflow for BRAIN for processing data. As shown, a BRG is created by the BRE. The BRE is an editor application program, operational for at least one or more of creating, editing, refining, compiling, executing, testing and debugging of a BRG. A screenshot of the GUI according to some embodiment so of the invention is shown in FIG. 3. Primitives area 310 include a plurality of objects (e.g., nodes) from a library that may be selected and used for/in a palate for a BRG, for performing modifiable, predefined tasks.

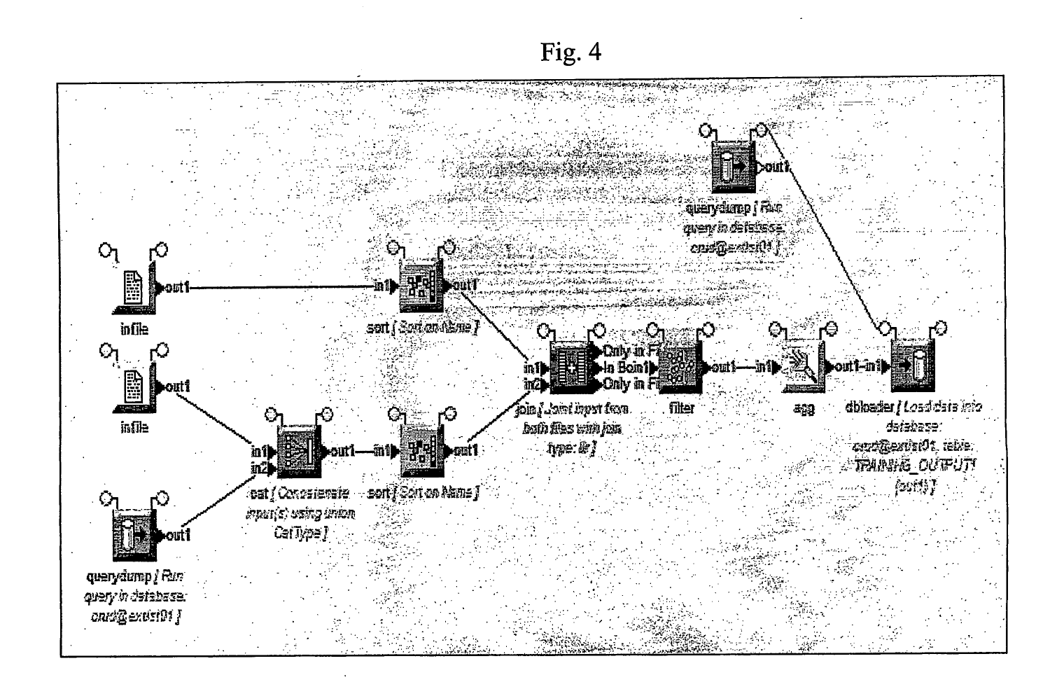

A BRG is a visual flowchart which may be used to arrange a plurality of nodes, each of which may be color coded (either via user preference or automatically by the BRE) and each of which may represent-one or more processing steps/tasks to be performed for processing and/or validating data. Results from one node may be forwarded to another node for further processing or storage in a file or database. FIG. 4 illustrates a representative example of a BRG illustrating a plurality of interconnected nodes. BRGs may be created to accomplished, for example, generic particular tasks, and moreover, such BRGs may be used as templates for other BRGs for similar tasks.

A completed BRG (for example) may be compiled (e.g., using the BRE or other compiling application) to form a BRX, an executable file which may be then executed by the controller using the server farm. Each computer of the server farm may be used to execute the one or more particular tasks of the nodes using, for example, drones.

### Nodes

Nodes are used in the present invention to perform a wide variety of tasks and each preferably includes user definable parameters/fields. The definable parameters allow a node to be easily modified so that it may be able to perform a particular desired task. Moreover, a user may also define additional parameters for a node for additional customization. Tasks that may be performed by nodes include (for example): filtering, sorting, cross-referencing, aggregating, separating, reading, writing, and the like.

In general, each node may include one or more inputs and one or more outputs, depending upon the type of node (i.e., the task that the node performs), and in some cases, nodes may not include an input or an output (or both).

Each node may be configured to perform one or more predefined tasks preferably using a general purpose scripting language. Such a programming language preferably includes simple grammar and syntax similar to that of, for example, Lisp or Scheme. The semantics for a preferred language may include a collection of low-level functions and/or built-in operators. Moreover, the execution model for the preferred language may be similar to that of AWK, SED, or PERL. Accordingly, whichever language is used, the source code for the language should reside on the server farm and/or workstation so that scripted tasks may be executed. For embodiments of the present application, such a general purpose scripting language will be referred to as “Expert” (e.g., Expert language, Expert code).

In that regard, each node may include modifiable, default Expert language to accomplish the task of the particular named node. For example, a filtering node may include the following default Expert language:

#describing output #1
(output 1
(output-all-input-fields) # same fields as input
)

This expression configures output #1 of the node, describing it as having all of the fields of the input. This particular example of a filtering node is a no-operation node—i.e., it simply writes every input record to the output. However, the Expert language may be modified so that records, for example, for a particular US state may be output (e.g., Massachusetts) as set out below:

#describing output #1
(output 1
(output-if (equals ‘state’ “MA”)) # MA only
(output-all-input-fields) # same fields as input
)

It is worth noting that this example of Expert language for a filtering node is not restricted to a particular type of input - it may be used where any input field named “state” is used. In some embodiments, a constraint may be included in the scripting that inputs require all referenced fields. This is preferable for iterative development since during construction of a BRG, if ever an additional piece of data is required from a data file (for example) to implement a particular business rule, the data is available (e.g., using the above Expert language, “output-all-input-fields”, which allows passage of all other data).

Results from the task performed by one node may provide input to another node. This may be done by graphically linking, in the BRG using the BRE (for example), one node to another by clicking on an output of one node and dragging it to the input of another node. The link defines the communication of data from the output of one node to the input of another directly via, for example, TCP sockets.

Typically, each node is named according to the task the node is performing, so that a user can quickly determine the task of a particular node. In that regard, a user definable parameter for naming or labeling the node may be included, where a user may simply type a name. In some embodiments, dynamic labeling of nodes may be included, in that, a label may be a short description determined from parameters of the node. For example, a sorting node that sorts data on the column “CustomerIS” could be adequately labeled with “Sort on CustomerID”. Each type of node may define a specific dynamic labeling technique, either through scripting or through textual substitution (see below) on a particular parameter name like “Custom Label” for example. In such a case, defining a parameter “Custom Label”=“Sort on {{Sort Column}}” accomplishes this automatically. Accordingly, if the parameter “Sort Column” is altered, the dynamic label may be altered instantly. Through a preference control, a user may turn dynamic labeling off.

Preferably, every node is associated with a particular node type, of a plurality of types of nodes provided in the primitives of the BRE, which determines the node's general function. Types may be defined in at least one of three ways: by a file, by a local library, and/or by a shared library. Those types that are defined in files may be the nodes that are associated with the primitives (i.e., commonly used nodes for BRGs) in the BRE. Such primitives may include: aggregate, composite, cat, Dbloader, filter, infile, join, lookup, query-dump and sort.

A node may comprise either a simple node, which may use a single binary or script to perform a particular action(s), or a composite node which may be defined by multiple nodes in a sub-BRG (for example). This recursive composition allows management of the complexity in large BRGs—a well-composed BRG using composite nodes is typically much easier to understand, edit, and debug than a BRG where all nodes are visible at once (e.g., a monolithic script).

Composition of simple nodes into a composite node may be accomplished by combining two or more nodes (base nodes), along with their interconnections, into a single node via a second or sub-BRG. A user can select a number of inputs and outputs associated with the base nodes of a composite node for use as inputs/outputs of the composite as a whole. A composite node may also be considered a pseudo node: in and of itself, a composite node performs no computations. Rather the nodes that make up a composite node determine the processing task(s) of the composite node. In a BRG, a user can choose to “drill into” (see FIG. 3, “Graph drill-down”) a composite node to see the configuration of the internal sub-BRG, to access the nodes that make up the composite and corresponding parameter values of each. It is worth noting that the composition of nodes in embodiments of the present invention may be analogous to an “integrated circuit”.

In the event that a node is contained within a composite node and requires a parameter value which has not been set, the value may be set on the composite node itself.

In other words, setting a parameter on a composite node implicitly sets the parameter on all members of the composite where it has not been set.

A library is a method for defining re-usable components (e.g. nodes) of one BRG, which may then be used in other BRGs by reference. BRGs are preferably setup to include an implicit library which is preferably stored in the same document as the BRG (or an associated document). In the case of library nodes, which may be either simple and/or composite nodes, each node may be available as a particular type (e.g., sort, aggregate, etc.). If the parameters of a library node are modified, the modification carry forth into every instance of the node used in every BRG.

Using an inheritance function, a new library node may be created based on a current library node (parent node) and inherit the parameters and associated default parameter values of the parent node library node type. Each parameter, however, may be overridden in the new library node. In addition, a user may define new parameters and establish a new node type with a different interface (for example). Thus, new nodes may be created based on other nodes using the inheritance function as a basis. This allows for easy reuse of functionality in BRGs, delivering time-savings and risk mitigation in creating and maintaining BRGs.

In accordance with the inheritance function, embodiments of the present invention may include rule for determining the setting of parameters in a node. For example, in one embodiment, the values for the parameters for a node may be sought out first from the particular node, then at the corresponding base (composite) node, then at a corresponding parent node, and finally, if a parameter setting is not found, it is sought at a BRG parameter level. BRG or graph level parameters are particularly useful for setting “global” properties such as directory paths, database usernames and passwords, and the like.

Inherited parameter values for a new library node from a parent node may be color coded so that a user can easily determine whether such parameters values have been inherited from another node. For example, inherited parameter values may be in blue text, and locally modified parameter values may be in black text. In one embodiment, deleting a locally modified inherited parameter values automatically restores the inherited value of the parameter.

When inheriting parameters from library composite nodes, it is often desirable to adjust the implementation of the composite node. For example, a library node may define a complex series of manipulations which are generally useful but in a particular single instance may not be quite right. Although one may copy and modify the composite node definition, it often leads to multiple sub-BRGs to maintain and clutters a library space with special case scenarios. Instead, using an augmentation process, the user can edit “shadow” nodes of the composite nodes. Shadow nodes represent instances of the internal implementation of the composite (i.e., the underlying nodes). Since alterations (e.g., additions and/or deletions) to a library composite node are instantly reflected in all derivatives, the shadow nodes provide a mechanism for interacting with and viewing the state of the elements of a library composite in a particular instance. Moreover, a user can override the parameter values of each of these shadow node, add new nodes to the composite node, disable shadow nodes, add new inputs and outputs or delete existing inputs/outputs, and alter the linking of the nodes within the composite node. Shadow nodes may be distinguished from explicitly instantiated nodes by a visual indication in the BRG, for example, by including a “shadow” behind the node.

With regard to the linking of the shadow nodes, since it can be confusing as to whether a connection between two nodes is inherited or locally modified, the BRE may display such connections differently to distinguish between the two. For example, inherited connections may be a dashed blue, while explicit modified or local linking may be solid black.

As stated earlier, template BRGs may be created to accomplish predetermined tasks. When creating such template BRGs, it is often desirable to have multiple sub-BRGs implemented simultaneously to allow a compiler to automatically choose one implementation over another. Accordingly, a Bypass node may be used to facilitate this functionality and is particularly useful for creating composite nodes that use multiple sources of mutually exclusive or optional data. The Bypass provides a visual indication that two or more alternate paths can be defined as the source of a single “virtual” data path. The bypass node chooses a first input that can be “satisfied” to realize the virtual data path as its output “Satisfied” may be defined as a node being enabled and all of its inputs linked to other satisfied nodes. To that end, a Bypass node may be satisfied if it is enabled and at least one of its inputs is satisfied.

In some embodiments of the invention, nodes may include a user-defined performance metric parameter. Such a parameter qualifies a node's eligibility to operate on a particular server. For example, a very large accumulator node may require a minimum of 4 gigabytes of RAM to operate and only one member of a server farm includes that much RAM. Accordingly, some embodiments of the invention provide the ability to declare the performance metric(s), and associating these metrics with nodes in the BRG and with servers in the farm. Thus, when used on a particular node, the node will be restricted to being assigned by the controller only to a server that has the required minimum metrics. In the event that two or more servers are eligible to run a node, the one with the best metrics (from the point of view of the node) may be chosen.

The value of a parameter can be partially or completely specified through a textual substitution mechanism. Syntactically, textual substitution may be indicated by a character prefix and suffix. For example, the prefix may be “{{”, and a suffix may be “}}”. Between the prefix and the suffix, a user can enter the name of a parameter. The value of this parameter may then be substituted in place of the text from the prefix to the suffix. The parameter may be evaluated using previously defined parameter inheritance rules stated above (i.e. check the node, then its base node(s), then its parent node(s), then the BRG level parameters). In the event that none of these are set, the BRE may prompt the user to set a BRG level parameter. If the user refuses, then the operation necessitating the substitution (typically execution or compilation) may be cancelled. However, instead of demanding a value, the user can include a default value in the textual substitution request by following the parameter name with a specified character (e.g., “=”) followed by a default value. If a blank value is acceptable, then the “=” may be followed immediately by the suffix.

According to some embodiments of the invention, textual substitution may be used with respect to the Boolean evaluation of whether a particular input or a node is satisfied. For example, if a syntax between the prefix and suffix of a two-character sequence“>>” (for example) is found, then any text before the “>>” may be determined as an input name or number. Any text following the “>>” may be determined to be a node name. Either can be blank, but preferably, not both.

The evaluation of the Boolean value proceeds by locating a node that matches the description. Accordingly, first the node where the substitution is required is examined. If the description cannot be found there, siblings of the node may then be examined, then analysis of the parent node (and so on). When the correct node is located, the Boolean value is returned as to the specified node or input being satisfied.

Textual substitution may be performed to specify user defined values to be incorporated directly into the source code, to define how user-defined parameters alter the behavior of a node, since embedded source code for Expert language corresponds to a multi-line parameter,.

By default, a node in a BRG is enabled, with an enabling attribute being, for example, a Boolean parameter. This parameter may be set explicitly, though inheritance or containment. As well, textual substitution may be used to define the value of “Enabled”. This feature allows nodes to be enabled/disabled on the basis of how other parts of the BRG are connected or satisfied (for example).

A node is, by default, also not mandatory to a BRG, and a mandatory attribute may be an ordinary Boolean parameter. As such, it can be set explicitly, through inheritance or containment. As well, textual substitution can be used to define the value of “Mandatory”. A mandatory node may include two special properties. First, if it cannot be satisfied, then attempts to compile the BRG into a standalone application will fail (where a suitable error message may be displayed). Second, an optional request to compile only mandatory nodes will elide any node that is neither mandatory nor needed by a downstream mandatory node. This provides an effective way to include debugging nodes in a BRG without compiling them for production.

For the parameters “Enabled” and “Mandatory” it may be sometimes necessary to combine multiple booleans. These parameters support boolean expressions in, for example, Expert syntax style, i.e. (and x x x) (or x x x) (not x). By default, the “Mandatory” parameter is always “anded” with the “Enabled” parameter. For example, a given database loader might be Enabled and Mandatory if

1) DatabaseLoading is true at the BRG level;

3) CustomerServiceRecords are connected and satisfied; and

4) SkipSlowSteps is false.

Thus, one may use boolean operators to combine these as follows:

Enabled = (and {{\hat{ }DatabaseLoading\hat{ }}}
{{\hat{ }>>CustomerServiceRecords\hat{ }}}
(not {{\hat{ }SkipSlowSteps\hat{ }}})
Mandatory = true

### Node Types

The following is an exemplary list of node types for use with embodiments of the invention. Please note that this list is not meant to limit the scope of the invention, but rather to give examples of the types of processes that may be setup for a node. As stated above, each node may include Expert language to perform particular tasks (e.g., to structure output for a next node process). Moreover, some of the node types listed below are directed to processing and/or validating data from a telecommunications system for revenue assurance and is meant as an example only and is not intended to be limited to such.

Accum: this node receives a data set and groups the output data set according to the accumulator specified in Expert. This node may be useful for calculating counts and sums on a data set. Works like Agg (see below); see also Accum-output and Define-accum. This node may include one input and one or more outputs.

Parameters

| Name | Type | Description |
|---|---|---|
| OutputExprFile | Inlinefile | Expert expressions that define output |
| | | structures. |

For example, having a record set with two fields, where the first field has an account number and the second field has a TN (telephone number), an Accum node may be used to group an output file by account number and add a field indicating the number of TNs for each account id.

Agg: this node receives a data set and groups the output data set depending on the aggregator specified in the AggExprFile attribute. This node may also be useful for calculating counts and sums on a data set. The input data is grouped (sorted) by the specified aggregator. This node may include one input and one or more outputs.

An Is-agg-done is a value that can be used within the context of an Agg node that is preferably maintained at a system level. In other words, there is no need for the user to update or reset the value. This is a Boolean value that will be true if the current line (input record) is the last line of a group that is determined by the value of the AggExprFile attribute, otherwise its value is false. If the AggExprFile attribute is set to 1, for example, then the aggregate is the whole input data set. This provides a method of determining when the end of an input data set is reached.

Parameters

| Name | Type | Description |
|---|---|---|
| OutputExprFile | Inlinefile | Expert expressions that define output |
| | | structure |
| AggExprFile | Inlinefile | Defines the fields to group the output by |
| | | (preferably one ouput). |

For example, if a record set includes two fields, the first field is an account number and the second field is a TN, the Agg node may be used to group an output file by account number and add a field indicating the number of TNs for each account id.

Binary: this node may be used to execute a binary executable file. The binary executable is deployed, for example, in the appropriate directory on a back-end server. This node may include zero (0), one (1) or multiple inputs and/or outputs.

Parameters

| Name | Type | Description |
|---|---|---|
| Binary | String | Path and name of the binary file to be executed. |

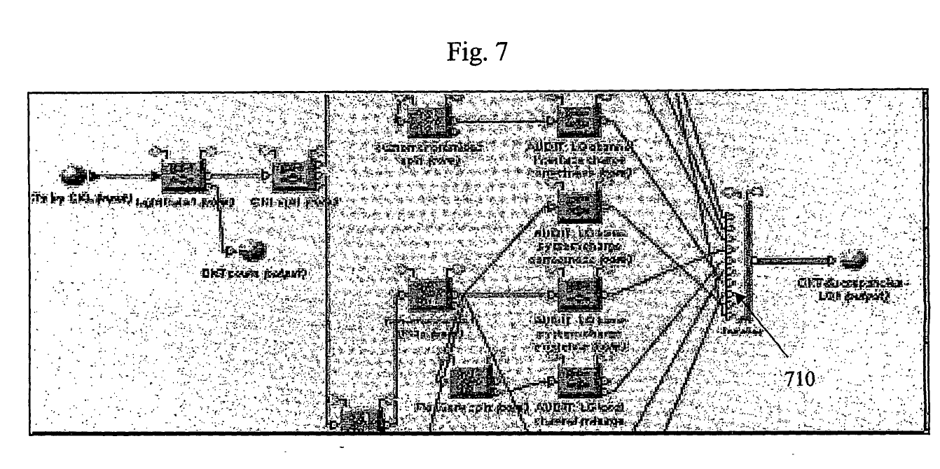

Bundler: this node may be used to combine multiple sources of input that all have the same format and creates one output source (see FIG. 7; node 710). The parameters/fields for this type of node are inputs and one output. This node is useful as a visual aide for BRGs where there are a large number of inputs and outputs associated to one node exist, which would clutter the BRG. A bundler node is similar to a composite node, but it is composition of data rather than a composition of operators. Before data streams can be accessed, however, a bundler node must be linked to a pseudo node called “unbundler”. Bundlers and unbundlers are analogous to male and female multi-pin connectors in electronic devices.

For example, this node may be used within the BRG that makes up a composite node, where the end result of a composite node is a large number of outputs. Thus, the outputs can be bundled up within the composite node's sub-BRG so that a single source of output can be shown. On the BRG where the composite node resides, the output of the composite node is sent to an Unbundler node (see below), where the respective outputs are broken down.

Cat: this node may be used to combine data sets, and may include one or more inputs and an outputs.

| Name | Type | Description |
|---|---|---|
| stripHeaders | String | A value of “true” populated here will drop the |
| | | column headers from the output data. |
| catType | String | “union” takes all columns from all of the inputs, |
| | | “intersection” takes all of the columns that are |
| | | in all of the inputs and “exact” requires that all |
| | | of the inputs have the same columns. |

Example: having input data consisting of three (3) input sources, where each source has one record and each source has one field named circuit_count, a resulting single output data set will include 3 rows, where each of the rows contains a circuit_count value from a respective input source.

Clock: this node defines sequential dependencies between the executions of nodes within a BRG. This node is preferably for display purposes as other functionality may be established using other nodes. For example, there may be a number of SQL statements that require execution in a certain sequence, where the structure of a BRG does not explicitly dictate the sequence. In such a case, one could associate the nodes in question by using a Clocks node.

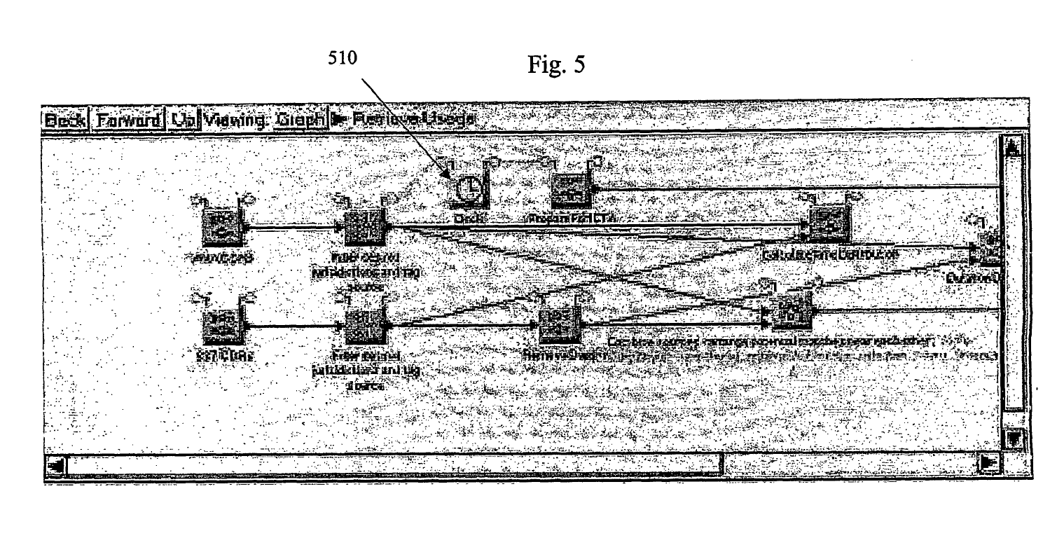

As shown in FIG. 5, clicking on the clock node attached to a first node and then dragging the mouse over to the second node in the sequence dependency creates a dependency line. Thus, as shown, the “Filter desired jurisdictions . . . ” 520 node must complete execution prior to the “Prepare for ICTA” node 530 to start execution.

CombineLineResultsFiles: this node may be used to combine a set of line level files from the directory specified in a ResultsDirectory node parameter into a library that is specified in the Library node parameter. This node may include one (1) input and zero (0) outputs.

Parameters

| Name | Type | Description |
|---|---|---|
| ShadowFileName | String | File that is used to store temporary |
| | | state information during the |
| | | execution of this node. This value should be |
| | | the same as the file initialized in an |
| | | InitializeCombineLineResultsFiles node. |
| Merge | String | “true” means that the records being |
| | | processed are in a summarized |
| | | format where usage data has been |
| | | grouped together for a particular WTN |
| | | (working telephone number). |
| | | “false” means that the records being |
| | | processed are in a raw call-by-call format |
| | | and have not been aggregated |
| | | by WTN. |
| Library | String | Directory where the output is placed |
| ResultsDirectory | String | Specifies the directory of the input to the |
| | | node, this is the directory where the output |
| | | from the usage proc execution resides |

Composite: this node may be used to group other nodes together visually and/or functionally; serving as a visual aide for BRGs where there are a large number of nodes that clutter the BRG. Thus, this node may include zero, one or multiple inputs and/or outputs.

Convert: this node may be used to convert data that is in a non-tab delimited format into a tab-delimited format (for example). This is similar to an Infile node (see below). Preferably, the data should already have a header. The node generally may include zero inputs and one output.

Parameters

| Name | Type | Description |
|---|---|---|
| InDelimiter | string | Input file delimiter |
| Convertfile | String | Identifies the input file to be converted. |

ConvertNonBrain: this node may be used to append field names to the top of each column of a file that has no headings, and may also be used to convert data to predefined delimited format.

Parameters

| Name | Type | Description |
|---|---|---|
| Header | String | Contains the headers to be added to each column |
| | | separated by commas. For example the value |
| | | might be >> file, date, type |
| InDelimiter | String | The symbol used to delimit the input file |
| File | String | The path and name of the input file |

ConvertPositional: this node may be used to convert an input file of fixed width (no header) to a delimited format (similar to an Infile node; see below). Specifically, the specification for the format may include colon separated field entries, where each field entry is of the form name, start, size. This node may include zero (0) inputs and one (1) output.

Parameters

| Name | Type | Description |
|---|---|---|
| Spec | String | The positional specification |
| Positionalfile | String | Identifies the input file to be converted. |

Dbloader: this node performs data loads into a database (e.g., Oracle), and may include one input and zero, one or multiple outputs.

Parameters

| Name | Type | Description |
|---|---|---|
| DBUSer | String | The database username |
| DBPassword | String | The database password |
| DBService | String | The database instance name |
| AbortThreshold | String | The number of rows that will be allowed to |
| | | error out before rolling back a data load. The |
| | | default value of this parameter is infinity. |
| DbOutputName | String | The output name to be used for the data load. |
| OutputExpr | Inlinefile | Expert language to define the output |
| | | structure of the data load; the output fields |
| | | created here should match the columns of |
| | | the table being loaded. |

Parameters

| Name | Type | Description |
|---|---|---|
| DBTable | String | The table to be loaded with data |
| MissingColumnBehavior | String | Possible Values: {“error”, “log”, |
| | | “ignore”}. This value defines the |
| | | behavior of the system if a record |
| | | that is about to be loaded is missing |
| | | data from a particular field in a table. |
| | | Ignore - Do nothing, continue |
| | | processing as normal |
| | | Error - stop processing |
| | | Log - log the discrepancy between |
| | | the data to be loaded and the table |
| | | structure, then continue processing |
| ExtraFieldBehavior | String | Possible Values: {“error”, “log”, |
| | | “ignore”}. This value defines the |
| | | behavior of the system if a record |
| | | that is about to be loaded contains |
| | | a field that is not defined in the |
| | | destination table. |

Diff: this node may be used to generate PC/MOU discrepancies between two homogenous line level input files, and may include two inputs and one output.

Parameters

| Name | Type | Description |
|---|---|---|
| Zone | String | This is a descriptor string, which is appended on to the |
| | | output records. Will typically be location based. |
| | | Ex.“BOSTON” |

Parameters

| Name | Type | Description |
|---|---|---|
| rundate | String | The date that the particular usage records |
| | | are from |
| threshold | String | The average MOU difference allowed per |
| | | call. |
| excludefile | String | This is a list of WTNs to exclude from |
| | | comparisons |
| discrepencytype | String | “AMA”, “Bill”, this will be a string value |
| | | that describes a the type of discrepancy |
| | | being checked for |
| Columns | String | Indicates which PC/MOU pairs to compare. |

DirectoryList: this node may be used to scan a specified directory to find all contents that match what is specified (which may support wildcarding). The contents may be output to the output file under the column name FileName

Parameters

| Name | Type | Description |
|---|---|---|
| Spec | String | The specification to use to scan the directory |
| DirectoryName | String | The directory to scan |

DummyInput: this node may be used to create a test input source consisting of one column and a specified number of rows with no data populated. A type may be specified by appending a :type identified after the name.

Parameters

| Name | Type | Description |
|---|---|---|
| header | String | Column header |
| Numlines | String | Number or rows |

ExecuteSubgraph: this node is used to execute a BRX file associated with another BRG, and may include one input.

Parameters

| Name | Type | Description |
|---|---|---|
| BrxFileName | String | Specifies path and file name of the .brx file to |
| | | be executed. The path of the file is server |
| | | oriented. |

Fatfinger: this node may be used to compare two data sources, to find “near” matches of TNs (e.g., off by one). This node type may include two inputs and one or more outputs.

Parameters

| Name | Type | Description |
|---|---|---|
| Inputfield1 | String | Specifies the first column to be compared |
| Inputfield2 | String | Specifies the second column to be compared |
| Fieldmask | String | Specifies which digits to look at. For |
| | | example, a value of xxxxxx1111″ would |
| | | only look at the last four digits of the |
| | | phone number. |
| OutputExprFile | Inlinefile | Expert language to determine the |
| | | structure of the output data. |

FileCat: this node may be used to concatenate multiple files into one input source. This may be used with a FilesFromLibrary node to combine multiple sets of usage into one file. This node may include one input and one output.

Parameters

| Name | Type | Description |
|---|---|---|
| FilenameExpr | String | This denotes the column header of the input |
| | | file, which should hold a set of file names. |
| | | This type of input file will come from a |
| | | FilesFromLibrary node. This can also |
| | | be an expression that uses the data in the |
| | | input file to construct a filename. |

FilesFromLibrary: this node maybe used to retrieve a set of usage files and stores the file names in an output file. This node may include an output.

Parameters

| Name | Type | Description |
|---|---|---|
| calldate | String | A string that describes the interval of the |
| | | calls to be loaded, typically it might look |
| | | something like the following: |
| | | ” 2003120820031209″ |
| filedate | String | Date that the usage files were created |
| Format | String | Format of the files to be retrieved, i.e. |
| | | “AMA”, “SS7” |
| Type | String | Type of the files to be retrieved |
| library | String | Directory path of the library where the |
| | | usage files reside |
| fileNameColumn | String | Header of the column in the output file |
| | | that contains the file names of the |
| | | retrieved usage files. |

For example, a sample set of input/output for a FilesFromLibrary node:

filename:string
/hosts/jigsaw-
sun/raid0/bdrosen/Testing/RLGHNCMO84G/lib/20031208/20031209/
AMA/CDRs
/hosts/jigsaw-
sun/raid0/bdrosen/Testing/RLGHNCMO84G/lib/20031208/20031208/
AMA/CDRs

The above parameters produced the following output:

filedate - 2003120820031209
calldate -2003120820031209
library - /hosts/jigsaw-sun/raid0/bdrosen/Testing/RLGHNCMO84G/lib
format - AMA
type - CDRS
fileNameColumn - filename

Filter: this node may be used to transform data using a simple pass through operation. For example, if instructed, one column may be removed from the output file. This node may include one (1) input and one (1) or more outputs.

Parameters

| Name | Type | Description |
|---|---|---|
| OutputExprFile | Inlinefile | Expert language expression(s) to alter |
| | | the structure and/or content of the input file |
| | | and produce an output. |

For example, a Filter node may take a usage file for a telecommunications system as an input and remove all records that do not have duration of greater than 5 seconds.

FinalizeCombineLineResultsFiles: this node may be used to finalize population of a library performed by one or more previous CombineLineLevelResultsFiles nodes using a temporary state file that is referenced in the ShadowFileName node parameter.

Parameters

| Name | Type | Description |
|---|---|---|
| ShadowFileName | String | Temp file used to store state information |
| | | associated to the activities of combining |
| | | Line Level usage files. There should be an |
| | | InitializeCombineLineResultsFiles |
| | | and a CombineLineResultsFiles node that |
| | | also have the same value in this parameter. |

Herefile: this node may be used to introduce a datastream directly into a BRG instead of loading it from an external file or database. Specifically, a parameter of the node defines the particular data directly.

Parameters

| Name | Type | Description |
|---|---|---|
| Herefile | String | Specifies particular data to be output. |

Infile: this node may be used to import data from a file into a BRG, and typically includes one output.

Parameters

| Name | Type | Description |
|---|---|---|
| Infile | String | Specifies the path and filename of the input data. |

InitializeCombineLineResultsFiles: this node may be used to initialize a temporary state file that is used by a CombineLineResultsFiles node when executed.

Parameters

| Name | Type | Description |
|---|---|---|
| ShadowFile | String | The name of the temporary state file to be used, |
| | | arbitrary |

Join: this node may be used to join two record sets based on predetermined criteria, populated in a JoinExprFile parameter. The two inputs preferably must be in properly sorted order as specified by the Expert join expression in the JoinExprFile parameter. This node may include more than two inputs and may have one (1) or more outputs.

Parameters

| Name | Type | Description |
|---|---|---|
| JoinType | String | Possible Values = {l (=left-outer), i, r(=right-outer), li, |
| | | ri} |
| JoinExprFile | Inlinefile | Expert language comparison statement, if the |
| | | comparison made for a record returns a 0, then both side |
| | | of the comparison are equal. Depending on the return |
| | | of the comparison and the JoinType specified, a given |
| | | record may continue to be processed so that it may be |
| | | output in the Output expression defined in |
| | | OutputExprFile |
| OutputExprFile | Inlinefile | Contains an expression that defines the output structure |

LineMatcher: this node may be used to determine Matched, UnMatched, Multiple-Matched lines/data in an input file. The node may output four streams: uniquely matched lines, multiply matched lines, unmatched lines, and matched ids. One use for a

LineMatcher node may be to remove duplicate call records from a set of usage data in validating data of a telecommunications system.

Parameters

| Name | Type | Description |
|---|---|---|
| MustMatchColumns | String | An array of column names by which the input |
| | | is sorted and which values must be identical |
| | | for a match to occur. |
| PrimaryRangedColumn | String | The name of the column that contains values |
| | | that will be used to perform the windowing |
| | | (this is an algorithm that determines what the |
| | | window of lines eligible for matching is). The |
| | | input should be sorted by this column after the |
| | | MustMatchColumns. |
| MaxPrimaryRange | String | This is the maximum difference between the |
| | | values of the primary ranged column for two |
| | | lines that the algorithm will consider to be a |
| | | match. |
| RangedColumns | String | An array of non-primary column names |
| | | whose values must fall in a range for a match |
| | | to occur. |
| MaxRanges | String | An array of numbers that correspond to the |
| | | ranges used for the RangedColumns |
| ColumnsThatCannotMatch | String | An array of column names that must NOT be |
| | | equal for two lines to match. |
| LineIdColumn | String | The name of the column that uniquely |
| | | identifies a line. |

Lookup: this node is similar to a Join node but includes additional performance capabilities. For example, lookup nodes load the second of two inputs (for example) into a cache that allows for faster processing of data comparisons. This node may be used when a second data set is small (e.g., a block of reference data). This node may load all records from the first input to be processed in OutputExprFile. If a match is found in the second input, a variable $is-match-found will be true, otherwise it will be false.

Lookup may be used for accomplishing “Inner join” and “Left join” operations. In the case of Inner join, join may result in the full Cartesian product of all of the matches in the second input, but lookup will result in one of the matches. Accordingly, it is recommended that the data in the second input be unique with respect to the keys to avoid any uncertainty in which data from the second input is available. This node may include a pair of inputs and one or more outputs.

Parameters

| Name | Type | Description |
|---|---|---|
| InputKeyExpressionFile | Inlinefile | Expert language for indicating a key value to be |
| | | compared, this may be a column name from the |
| | | larger input that is not meant to be cached. |
| LookupKeyExprFile | Inlinefile | Expert language for indicating a key value to be |
| | | compared, this may be a column name from the |
| | | smaller cached input that is being compared. |
| OutputExprFile | Inlinefile | Expert language for defining output. Any |
| | | records that pass the defined comparison test |
| | | will be processed by the Expert code in this |
| | | parameter. |

MergeSortedUsage: in the case of telecommunications data validation, this node may be used to receive a file with usage records sorted by WTN, which have MOU-paycount pairs. The output(s) of this node may be an aggregated sum of usage totals for each WIN in the input file. Preferably, the input file for this node is sorted.

MultiMatcher: this node may be used to determine Matched/Unmatched lines/data from multiple matched info. This node may output two (2) streams: uniquely matched lines and unmatched lines. Generally, this node uses a list of matched IDs as input from a LineMatcher node and multiple matched lines from a LineMatcher node, and may include a pair of inputs and a pair of outputs.

Parameters

| Name | Type | Description |
|---|---|---|
| PrimaryRangedColumn | String | Name of the column than contains values that |
| | | may be used to find the closest match |
| | | between multiply matched records. |
| RangedColumns | String | An array of non-primary column names |
| | | whose values are used to find closest match. |
| ColumnsThatCannotMatch | String | An array of non-primary column names |
| | | whose values are used to find closest match. |
| LineIdColumn | String | The name of the column that uniquely |
| | | identifies a line. |

Outfile: this node may be used to write an input to a specified file.

Parameters

| Name | Type | Description |
|---|---|---|
| OutFile | String | Filename to save to |

Perffunc: this node may be used to execute a Perl script, and may include zero (0), one or more inputs and/or outputs.

Parameters

| Name | Type | Description |
|---|---|---|
| module | String | Perl module to be executed from |
| function | String | Perl function to be executed |

Pythonfunc: this node may be used to execute a Python function, and may include zero (0), one (1) or multiple inputs and/or outputs.

Parameters

| Name | Type | Description |
|---|---|---|
| module | String | Python module to be executed from |
| function | String | Python function to be executed |

Querydump: this node may be used to execute one or more SQL queries from a database (e.g., oracle) and provide the results as a virtual input. In general, a Querydump node will not have an input other than the virtual input, but may have one or more outputs.

Parameters

| Name | Type | Description |
|---|---|---|
| DBUser | String | Oracle DBUserName |
| DBPassword | String | Oracle DB Password |
| DBService | String | Oracle DB Service |

Parameters

| Name | Type | Description |
|---|---|---|
| QueryFile | Inlinefile | Holds the SQL that queries the database, the |
| | | SQL here does not need to be embedded |
| | | within Expert code. |
| OutputExprFile | Inlinefile | Expert language that defines the output for |
| | | the data that is retrieved from the SQL in the |
| | | QueryFile field. |

Rotatefile: this node may be used to create a file with one line, containing a column per line in original file. In some embodiments, TypeDefault takes precedence over TypeColumn. If neither is set, string is the default.

Parameters

| Name | Type | Description |
|---|---|---|
| NameColumn | String | This value should be equal to one of the column names of |
| | | the input file. The value under this column for each row |
| | | of the input file will turn into a column header on the |
| | | output file. |
| ValueColumn | String | This value should be equal to one of the column names of |
| | | the input file. The value under this column for each row |
| | | of the input file will now be a field value. |
| TypeColumn | String | This value should be equal to one of the column names of |
| | | the input file. The value under this column for each row |
| | | of the input file will now be the type of the column in the |
| | | output (optional) |
| TypeDefault | String | The type to use for all columns (optional) |

### EXAMPLE

| Input File: | |
|---|---|
| bar:string foo:string | |
| hello | bye |
| hello | bye |
| NameColumn: foo | |
| ValueColumn: bar | |
| Output File: | |
| bye:string bye:string | |
| hello | hello |

Sort: this node may be used to sort an input file by a specified field(s). If more than one input is used, the column types and order should be identical across all inputs.

Parameters

| Name | Type | Description |
|---|---|---|
| CompareOrder | String | Defines the field that we are sorting by. |
| | | Records will be sorted in ascending |
| | | order. |
| Unique | String | If “true” (string value) is populated, |
| | | duplicates are dropped. |
| CompareOrderExpr | Inlinefile | Expert language to determine |
| | | comparison order (instead of |
| | | CompareOrder). |

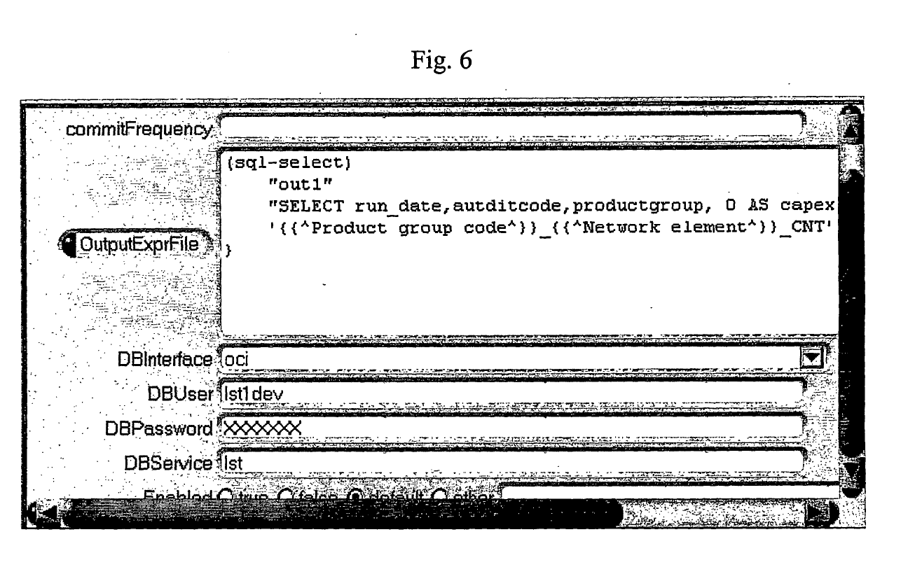

Sqlrunner: this node may be used to execute SQL statements on a given data set and may be used, for example, to query the Oracle DB. Although this node is very similar to the Querydump node, it is not typically as efficient. This node may be used to insert data into a database as well. If there is no input, the node is typically run once; if there is an input, it will run once per input line. See FIG. 6.

Parameters

| Name | Type | Description |
|---|---|---|
| DBUser | String | Oracle DBUserName |
| DBPassword | String | Oracle DB Password |
| DBService | String | Oracle DB Service |
| CommitFrequency | String | How many records are processed |
| | | prior to committing an SQL transaction |
| | | on a given data set. This field is not |
| | | required. |
| OutputExprFile | Inlinefile | Expert language for an SQL statement |

Tail: this node may be used to remove records from an end of a given input dataset.

Parameters

| Name | Type | Description |
|---|---|---|
| Number | String | The first X rows of an input data source will be written |
| | | to an output, where X is the number entered in this |
| | | parameter. |

Unbundler: this node may be used as a visual aide for BRGs where there are a number of inputs and outputs present that clutter a BRG. Unbundlers are typically used in conjunction with composite nodes (which typically includes a number of outputs). As shown in FIG. 7, in order to simplify a BRG visually, substantially all (or preferably all) of the outputs are loaded into a bundler node 710 so that a composite node can appear to have one output source as opposed to more than 10.

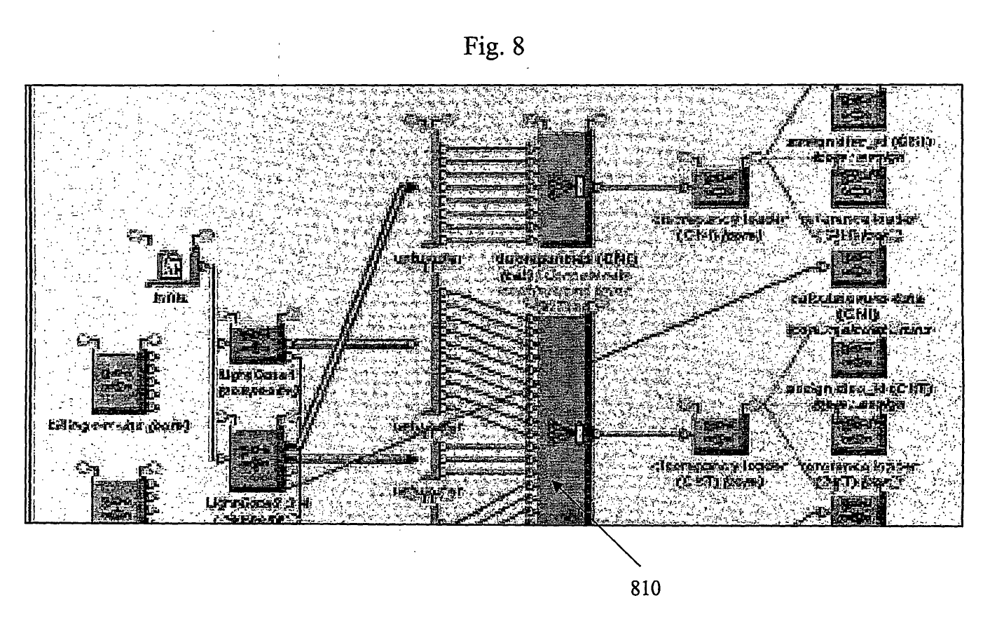

Accordingly, as shown in FIG. 8, a composite node includes a “single” output 810 which is sent to an unbundler, which then breaks down all of the actual outputs and directs them to the appropriate nodes.

UsageReader: this node may be used to validate telecommunication data, for example, to process usage of a specified type, making the input fields in input available as input 1 and the fields of the CDR available as a virtual input 2. The following are the fields and types supported by the CDR input:

FileNumber (representing the line number of the current usage file from
input 1)
OrigDisplayNumber - long integer
TermDisplayNumber - long integer
TermResolvedNumber - long integer
ConnectDate - integer
ConnectTime - integer
DisconnectDate - integer
DisconnectTime - integer
HoldSeconds - float
CallType - integer (has constants for the possible values)
Features - integer (bitfield of possible values, all of which have constants)
ChargeType - integer (has constants for the possible values)
BillingNumber - long integer
BillingSeconds - float
Jurisdiction - integer (has constants for the possible values)
OrigRateCenter - string
OrigLATA - integer
OrigState - string
OrigCountry - string
TermRateCenter - string
TermLATA - integer
TermState - string
TermCountry - string
PeerRateCenter - string
PeerLATA - integer
PeerState - string
PeerCountry - string
RecordingRateCenter - string
RecordingLATA - integer
RecordingState - string
RecordingCountry - string
OrigOCN - string
TermOCN - string
PeerOCN - string
RecordingOCN - string
OrigCarrierCode - string
TermCarrierCode - string
PeerCarrierCode - string
RecordingCarrierCode - string
OrigCarrierType - integer (has constants for the possible values)
TermCarrierType - integer (has constants for the possible values)
PeerCarrierType - integer (has constants for the possible values)
RecordingCarrierType - integer (has constants for the possible values)
IXC - integer
OrigRoutingNumber - long integer
TermRoutingNumber - long integer
OrigEndOffice - string
TermEndOffice - string
Peer - string
Recording - string
RoutingType - integer (has constants for the possible values)
RecordingPoint - string
OPC - string
DPC - string
InboundTrunkGroup - integer
InboundTrunkGroupMember - integer
OutboundTrunkGroup - integer
OutboundTrunkGroupMember - integer
SwitchDirection - integer (has constants for the possible values)
CarrierDirection - integer (has constants for the possible values)
SourceType - integer (has constants for the possible values)

The following constants are also provided which will be used to test the values of certain of the fields of the cdr input:

General
%Other
%Unknown
%NotApplicable
CallType
%Local
%LocalToll
%LongDistance
%LocalDirAssist
%LongDistDirAssist
%Emergency
%Free
Features
%ThreeWayCall
%AutoCallback
%ForwardedCall
%RemoteForwardedCall
%OperatorAssisted
%Duplicate
ChargeType
%Normal
%TollFree
%PremiumFee
%CallingCard
%Collect
%CoinPaid
Jurisdiction
%IntraLATA
%Intrastate
%IntraLATA_Interstate
%Interstate
%IntraNANP
%International
Routing
%Direct
%Tandem
Direction
%Inbound
%Outbound
%Transit
%Internal
%External
Source Type
%AMA
%OCC
%SS7
%DUF
%RetailBill
Carrier Type
%UNKNOWN
%OTHER
%CAP
%CLEC
%GENERAL
%IC
%ICO
%L_RESELLER
%LEC
%PCS
%RBOC
%RESELLER
%ULEC
%W_RESELLER
%WIRELESS

This node also supports four expert operators: npa, nxx, line and FeatureSet. Npa, nxx and line yield the relevant portions of a passed in TN. FeatureSet is a bit operator that tests if a specified bit is present in the specified bitfield.

Parameters

| Name | Type | Description |
|---|---|---|
| InputFileNameColumn | String | The column name in the input file to |
| | | use to get the usage filename |
| ReaderType | String | The type of registered usage reader |
| | | to use (i.e. AMA) |
| UseSwitchMap | String | Whether or not to augment cdr data |
| | | with lerg lookup data. (optional, |
| | | default is false) |
| OutputExprFile | Inlinefile | Expert language to operate an SQL |
| | | statement. |

### BRXs

As stated earlier, the BRE may compile a BRG into a BRX, which is an execution file which is executed by the controller using the server farm at a desired frequency. The controller may be a command-line Java application that can be automated through cron or another similar utility (for example). Moreover, the BRE may function as a controller when BRGs are executed from within it.

The controller analyzes the BRX and distributes the task(s) of each of the nodes over available processing resources of the server farm, which uses drones to perform each of the tasks, preferably in a most efficient manner. Specifically, the controller may delegate work at a granularity of individual BRX nodes, and coordinate communication between drones executing the processes of interconnected nodes. When a drone completes a task, the controller may schedule the process of a next available node for execution on that drone.

### Creating a BRG

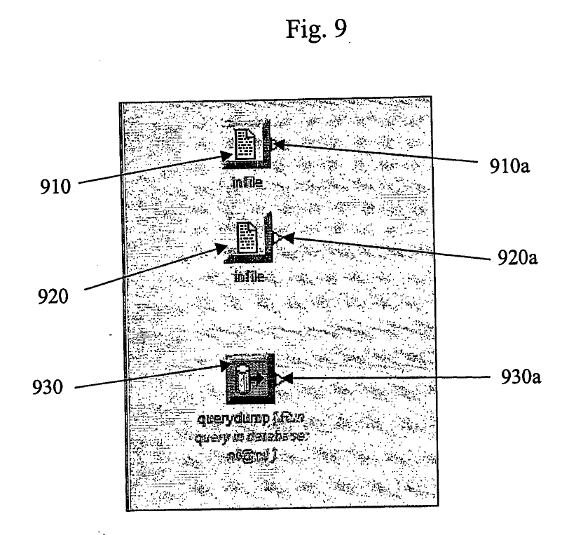

FIGS. 9-27 illustrate an example of creating a BRG using the BRE. In this example, a BRG will be constructed to validate data from two inputs files and a database, concatenate the two input files, sort the input files, join the data from the two input sources (files and database), filter the data from the join, aggregate the results and then load the results into a database table. One of skill in the art will appreciate that the following process is merely an example and is not meant to limit the scope of the present invention. As shown in FIG. 3, a screenshot of the BRE, and FIG. 4, a screenshot of a BRG, various nodes may be selected from the primitives node library 310, but clicking on the desired button.

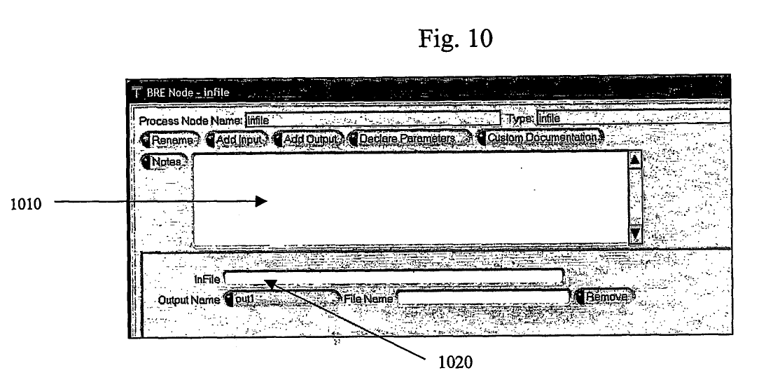

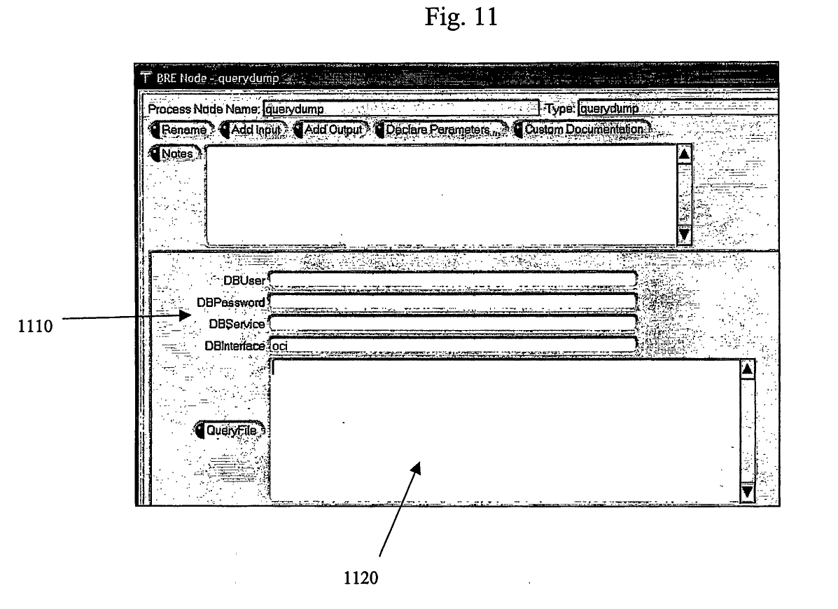

In constructing a BRG according to the present example, as shown in FIG. 9, an Infile button maybe used to add Infile nodes 910 and 920 into the BRG. In addition, in this particular BRG, a Querydump node 930 is added to the BRG, each having a corresponding output 910a, 920a and 930a, respectively. These nodes serve to retrieve data from a file or database that the BRG will process/validate. Parameters of a node may be changed by, for example, right-clicking on the particular node, which generates, for example, a popup window listing the particular customizable parameters for the particular node. As shown in FIG. 10, for an Infile node, the parameters may include notes 1010 to add comments about the node (e.g., which may automatically be displayed when the mouse is hovered over the node). As stated in the previous section, the location of the data file to retrieve is specified at 1020. Other parameters may be declared by clicking on a “declare parameters” button. For the Querydump node, login information 1110 (FIG. 11) for logging into the database having the desired data and query language 1120 to perform a search of the database to retrieve specific data.

Outputs and inputs may be managed in the parameters window as well, in that inputs and outputs may be added or modified (e.g., renamed) by clicking on the “Add Input” or “Add Output” button, which displays a popup window for each (see FIG. 12).

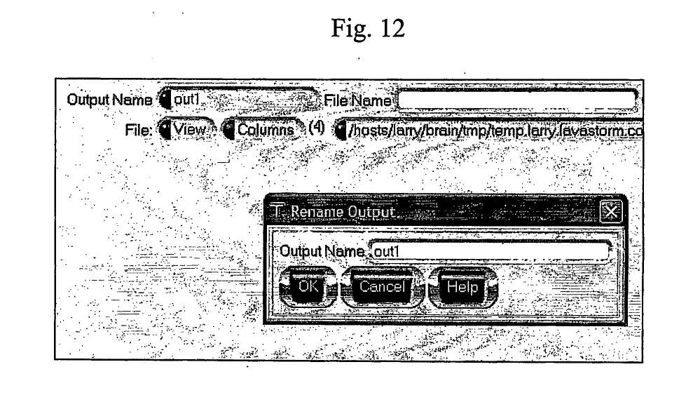

FIG. 13 illustrates the addition of concatenate node (Cat) 1310 in addition to the two infile nodes and a querydump node. In the instant example, the Cat node concatenates data from one of the Infile nodes and the querydump node. To integrate the Cat node with another node, an output of one of the Infile nodes is linked 1320 to the input of the Cat node (e.g., clicking on an output arrow on one node and dragging it to an input arrow of another node).

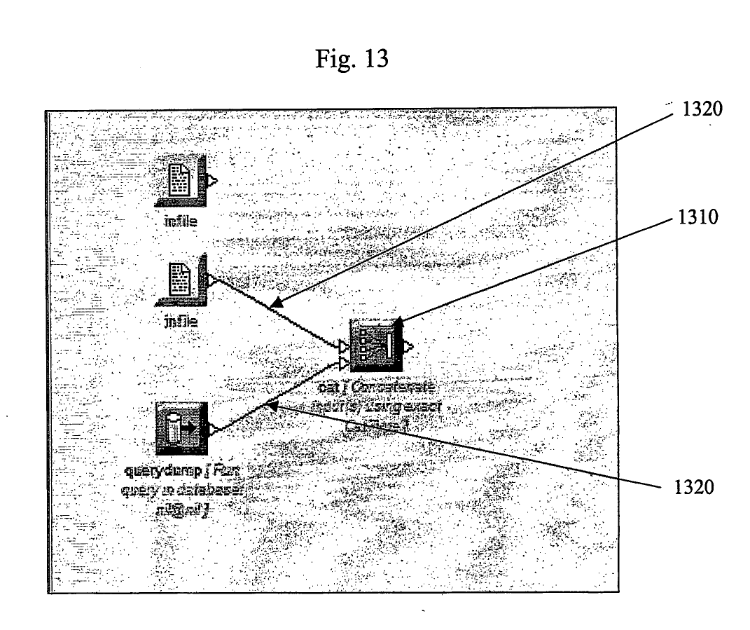

The parameters of the Cat node may be modified. As shown in FIG. 14, headers may be stripped from the data (entering “true”), and the type of concatenation may be specified (union, intersection, exact). A listing of the inputs and outputs of the node may also be displayed. In this example, the Cat node will be a union.

During the process of creating a BRG, nodes may be executed at any time to determine (test/debug) if they are performing the required task(s). During such an execution, the nodes and/or inputs and outputs may be color coded to indicate a status of processing. For example, unprocessed nodes may be include a first color (e.g., gray), nodes which are currently processing may include a second color (e.g., yellow), nodes which have successfully processed may include a third color (e.g., green) and those that have failed processing may include yet a fourth color (e.g., red). With regard to inputs and outputs, particular colors may indicate if the input or output is connected, satisfied, missing, in process or complete.

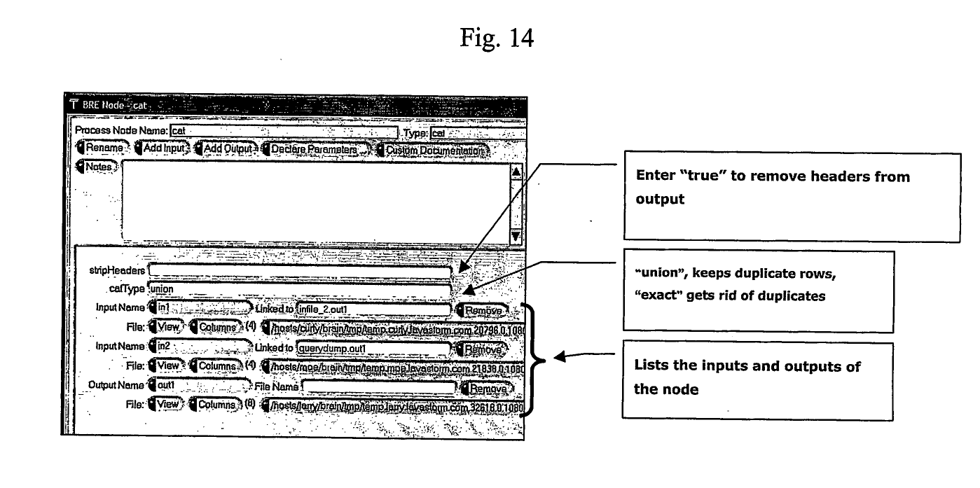

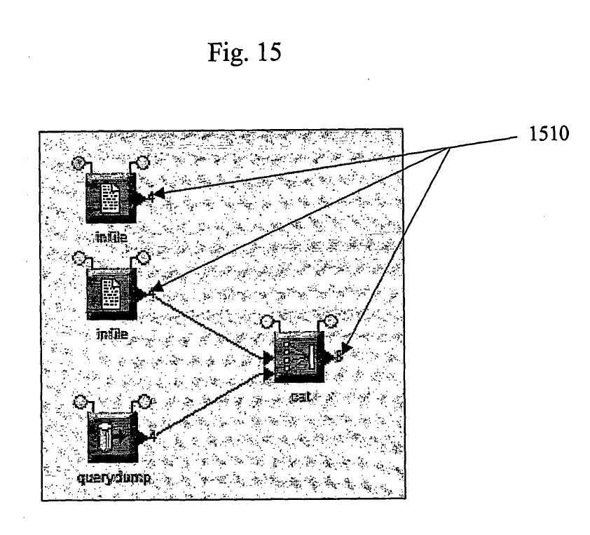

After any execution, whether to debug certain nodes or to execute an entire BRG, data results for each node may be displayed on the BRG. For example, line counts 1510 (the number of data rows processed) may be displayed adjacent the node (or on the node, or via a hovering mouse) at the output (for example) (see FIG. 15). Displaying the results of the processed data may be accomplished via a button in the node properties window (see FIGS. 16A-16C).

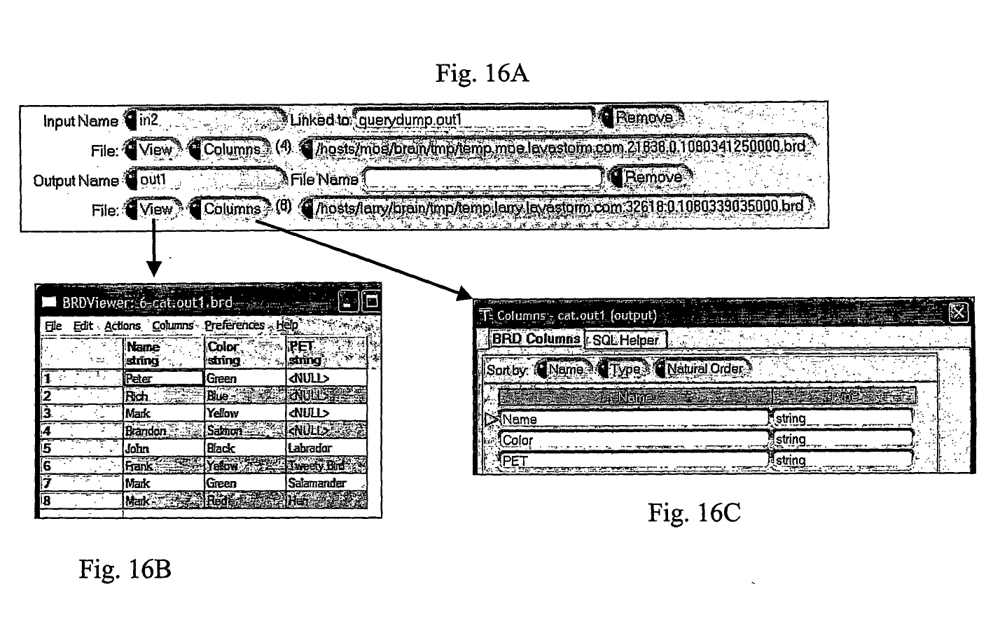

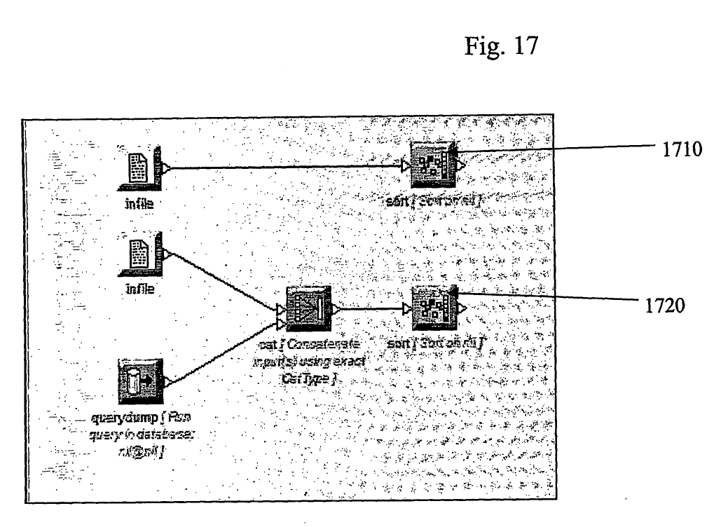

As shown in FIG. 17, two sort nodes 1710, 1720 are added to the instant example: one to sort data from the output of one of the infile nodes (1710), and another to sort data from the output of the Cat node (1720). The parameters of each sort node may include a note area 1810 (FIG. 18) to add notes about the node, a compare order area 1820 to define the field that is used for sorting (may be predefined to sort in a particular order—e.g., ascending), and an area to add in custom comparison logic 1830 using Expert language. In addition, a “unique” area 1840 may be included, which if “true”, duplicate data is eliminated. In the example shown in FIG. 17, “Name” is used for sorting the data (in ascending order).

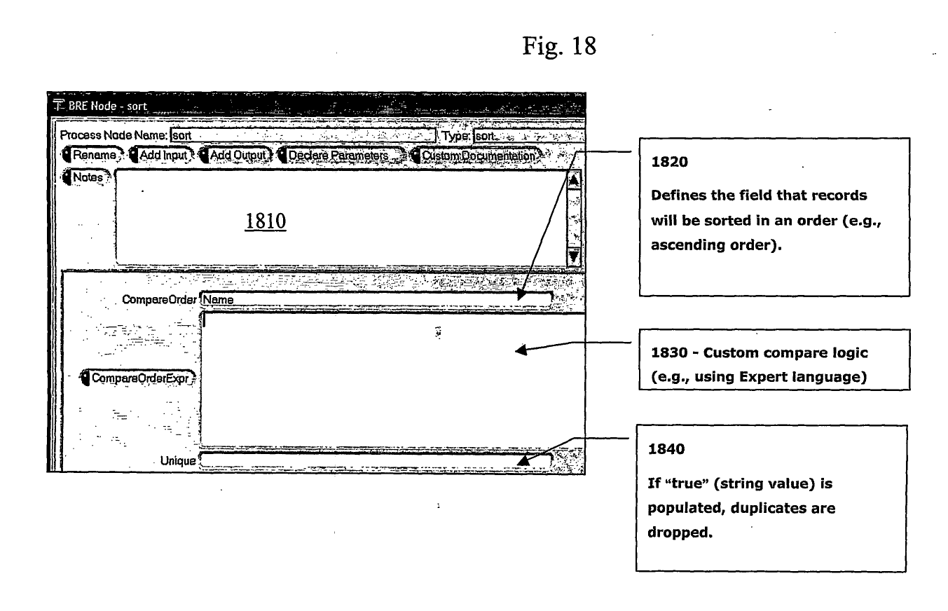

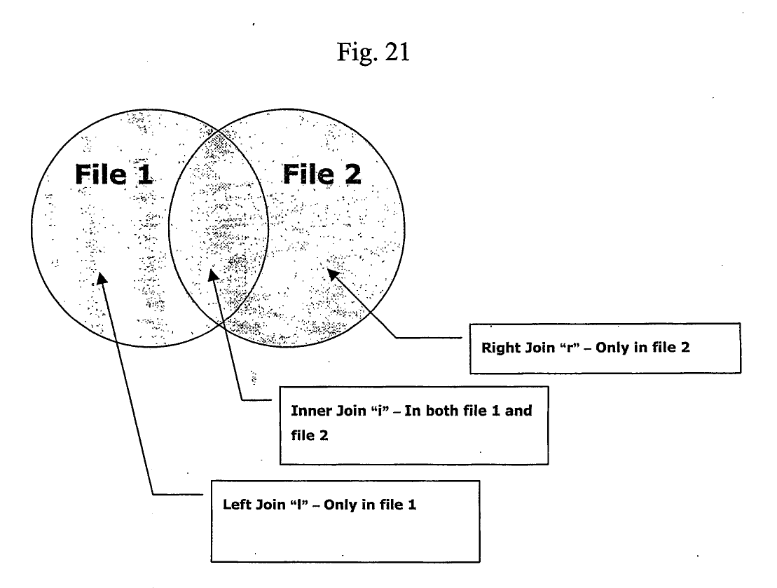

As shown in FIG. 19, a join node 1910 is added in the example, and defined to include a total of two inputs and three outputs, with the outputs: “Only in File 1”, “Only in File 2” and “In both”. Then, using Expert, the logic for the join may be drafted (see FIG. 22). In this example, the following logic is used: (cmpl¹‘:I Name’ ‘2:Name’). This logic determines whether there is a match or not between the data results from the sort nodes.

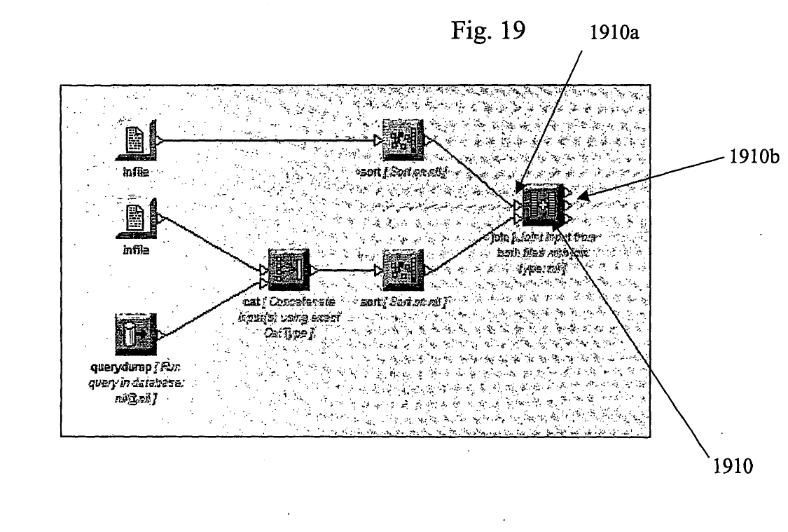

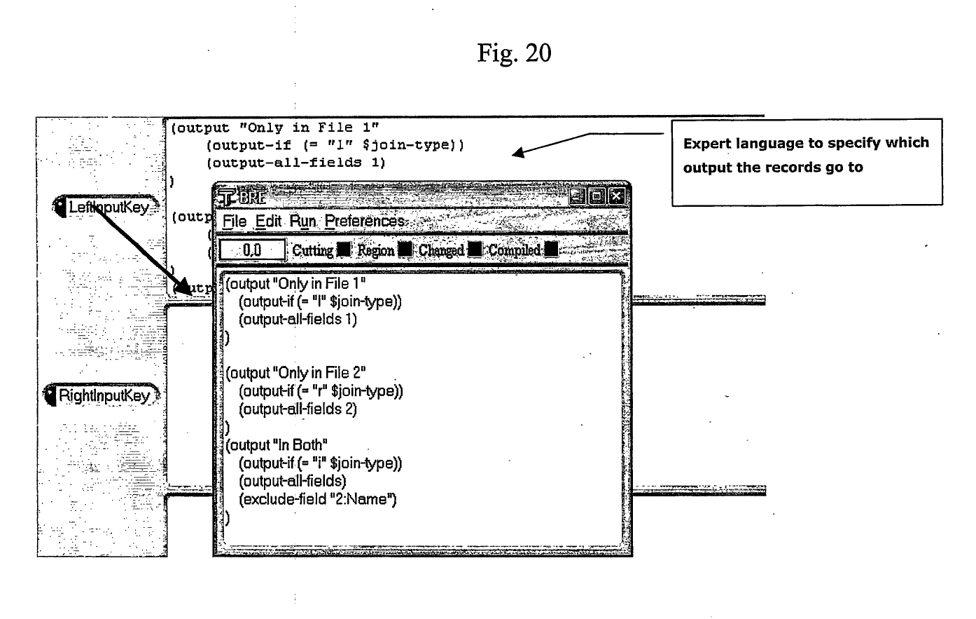

In FIG. 20, the user may indicate the join types—i.e., what records to include in the output: left (outer) output, right (outer) output and inner output (“lir”). FIG. 21 illustrates a Venn diagram illustrating these parameters: File 1 is a left join “L”—“Only in File I ”; File 2 is a right join “R”—“Only in File 2”, and Inner join “i”—“In both file I and file 2”. “cmp” is an example of a command that may be used in a scripting computer language to perform a comparison between data.

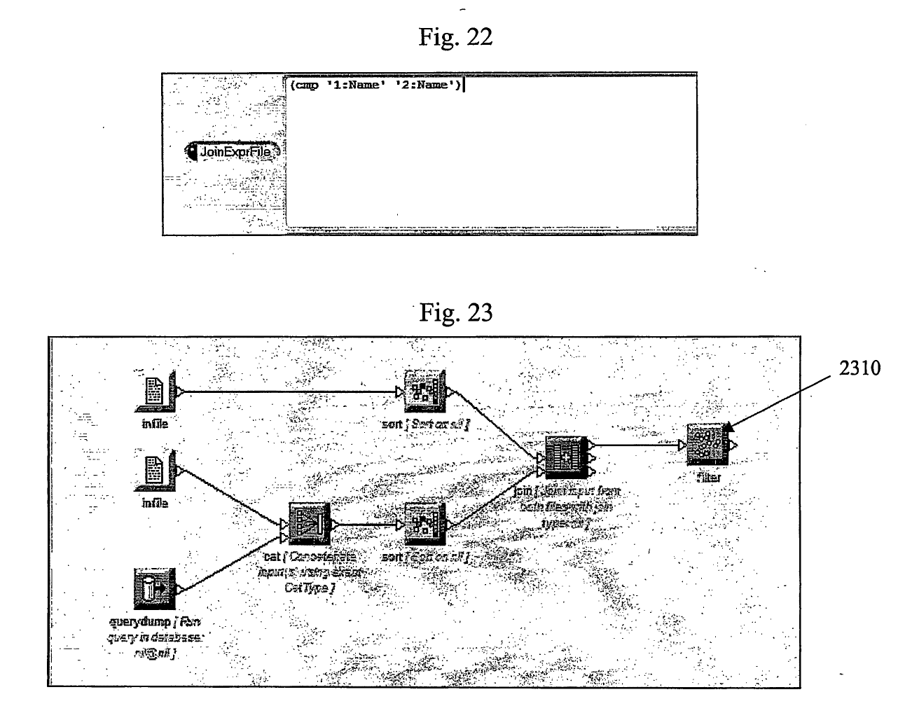

A Filtering node 2310 is added to the example BRG in FIG. 23. The Filtering node may be used to transform file data using Expert. For example, a single column of data may be removed, or, in the case of validating telecommunications data, a usage file could be filtered to remove any records that do not have a duration greater than 5 seconds, for example. In the instant example, the “Only in File 1 output is linked to the input of the Filtering node, and is used as a simple pass through to illustrate the use of the node. To that end, Expert language to accomplish such an output structure is:

(output “out1”
(output-all-fields)
)

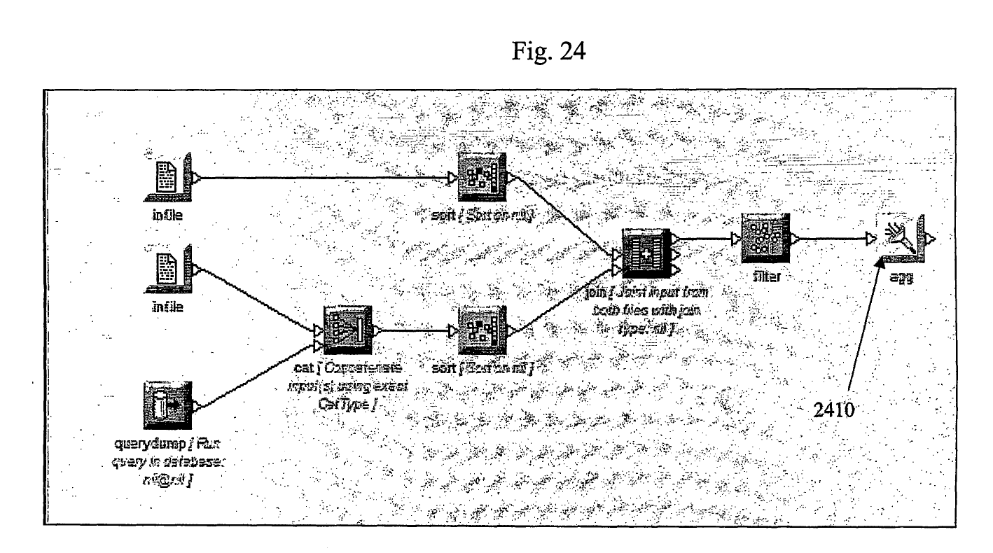

As shown in FIG. 24, and Agg node 2410 is added to process a data set and group the output data set depending on the aggregator specified (e.g., in an AggExprFile attribute). The Agg node is useful for calculating counts and sums on a data set. In the instant example, the output of the Filtering node is wired to the input of the Agg node.

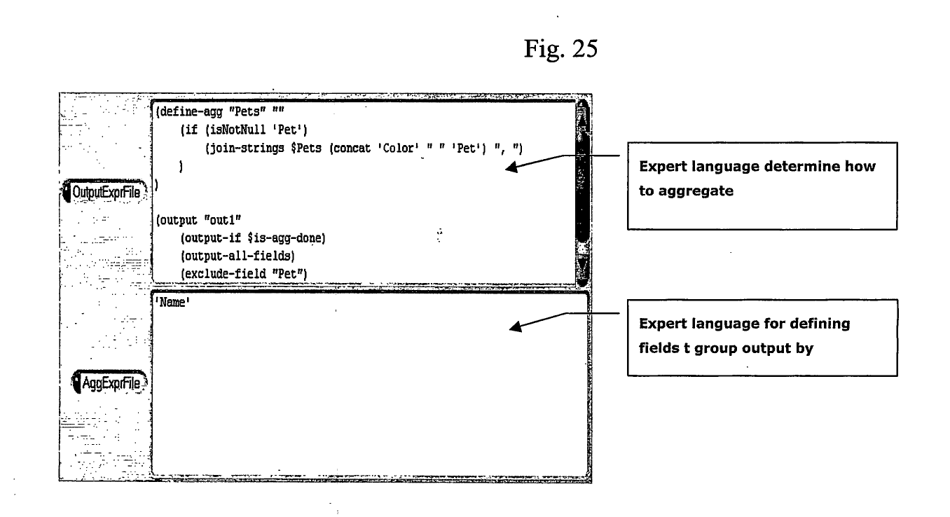

Using Expert, the output of the Agg node is established as shown in FIG. 25. Also shown is the AggExprFile parameter which defines the fields to group the output. Preferably, the Agg node includes a single output.

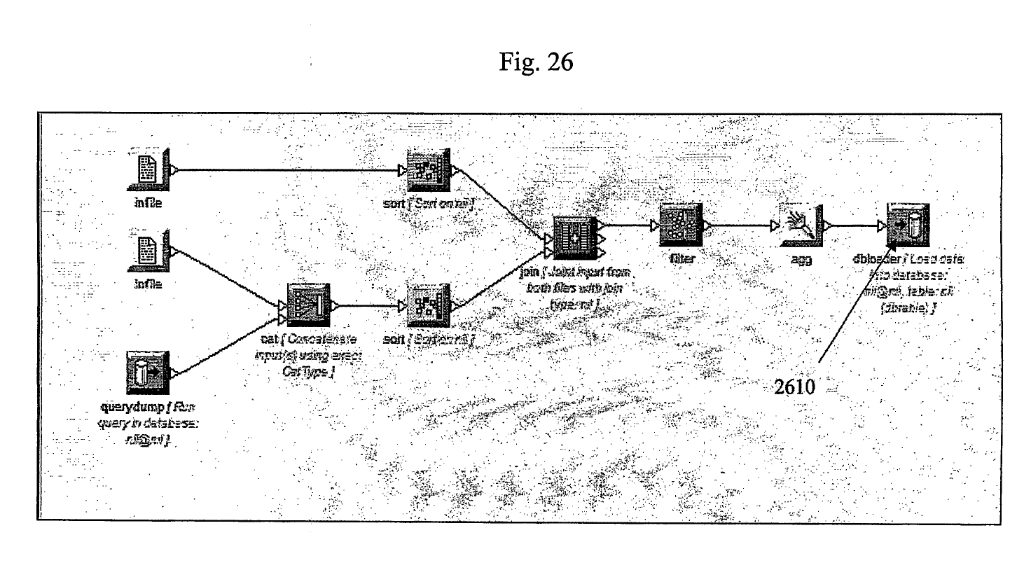

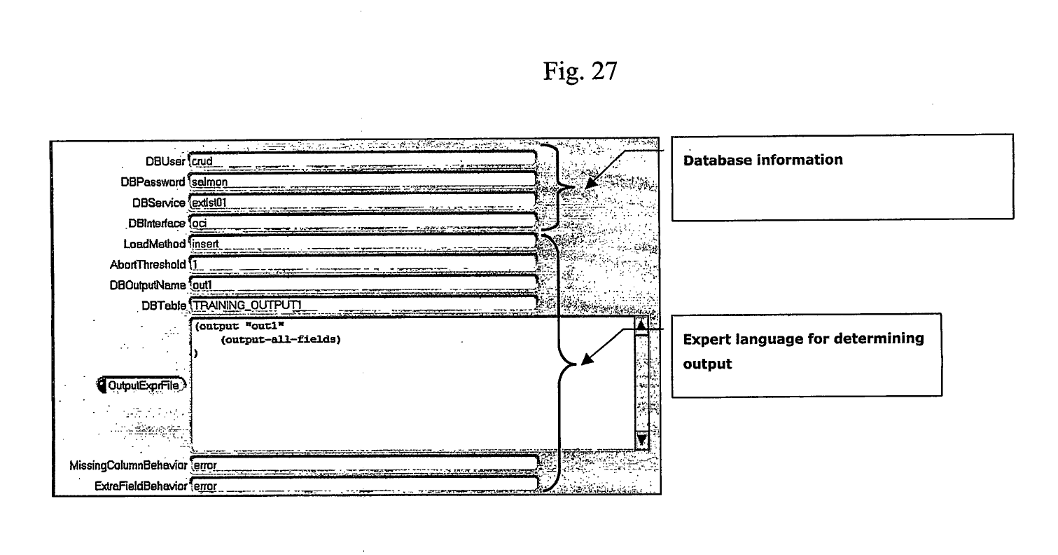

The results generated by the Agg node may be loaded into a database using the dbloader node 2610, as shown in FIG. 26 (the completed BRG): the output of the Agg node is wired to the input of the dbloader node. FIG. 27 shows a popup window for modifying the parameters of the dbloader node, with fields for specifying the particular database to store the data. Expert may be used to structure the output for storage on the database. In the instant example, all the fields produced by the agg node are stored in the database. The completed BRG is now ready for execution into a BRX so that is may be processed by a server farm.

### Other Features

Debugging: While a BRG is being created, it may be “debugged” along the way. For example, using the BRE in a debugging mode, datastreams from each node may be written to a temporary file which may be tracked and fed back to a remote client application for examination by a user to determine how the BRG (or particular node) is performing. For efficiency, a predetermined number of rows of data (e.g., 10 rows) may be specified so that one need not retrieve an entire (large) file.

Moreover, with regard to such temporary file storage, since such temporary files stored on a server during debugging can exceed the storage capacity of the server, an “aggressive” deletion process may be included in embodiment of the invention in which temporary files no longer needed by any node are deleted. Conversely, while a BRG is running, it may be desirable to retain downstream temporary files even though they are scheduled for deletion (or replacement). Accordingly, a “lazy” deletion process may be included in embodiments of the invention. Using such a process, a temporary file is not deleted until the time that a node replaces it.

### Servers and Server Farms

BRGs and BRXs may be executed on server farms. The servers may be any computer, e.g., multiprocessor, desktop PCs, anything in between, or a heterogeneous mixture. Embodiments of the invention may be written in Java, for example, so each could theoretically run on any platform (e.g., HP-UX/PA-RISC, Solaris/SPARC, Red Hat Linux/i386, and Win32/i386). A server farm may be any mixture of these platforms.

While data is often communicated from the output of one node to the input of another (“linking”) directly via TCP sockets (for example), some files may be created to be used as temporary storage. For example, during BRG development, the BRE may direct one or more drones to write intermediate outputs to a file to aid in iterative development. In production mode, the controller may direct drones to use files to avoid potential deadlock scenarios (for example). As a result, each of the servers in a farm may require access to such files written by other servers. In addition, the same filename used by a drone on one server should be usable on every other server in the farm.

This may be accomplished using a central file server with a volume mounted in a consistent location. Another option includes having each server export a volume, and for each server to mount every other servers' volumes (in a consistent way). Each server may then be configured to write temporary data files to its local volume, using the standard path. For example:

/server-farm/server-1/ mount of server-1 volume
/server-farm/server-2/ mount of server-2 volume
...
/server-farm/server-i/ link to local volume
...
/server-farm/server-n/ mount of server-n volume

The foregoing description is considered as illustrative only of the principles of the various embodiments of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

The present application also incorporates by reference, in its entirety, the disclosure of the priority document for the present application, U.S. provisional patent application no. 60/516,483, filed Oct. 30,2004, entitled, “SYSTEM AND METHOD FOR IDENTIFICATION OF REVENUE DISCREPANCIES”.

What is claimed is:

1. A method for processing data using a graphical user interface of a computer system comprising:
arranging a plurality of nodes in a graph, wherein each node represents at least one processing step for processing data by a processor and wherein at least one of the plurality of nodes comprise at least one data retrieval node for retrieving data for validation;
establishing at least one output from substantially all of the plurality of nodes;
except for the at least one data retrieval node, establishing at least one input to each of the plurality of nodes;
configuring one or more parameters of each node;
linking at least one output of each of substantially all of the plurality of nodes to an input of another node, each link representing a data flow;
sequencing a dependency among the plurality of nodes; and
establishing processing logic in at least one node to process data in a predetermined manner.

2. The method according to claim 1, wherein the data retrieval node comprises an infile node which retrieves data from a particular data file.

3. The method according to claim 1, wherein the data retrieval node comprises a querydump node for retrieving data from a query of a particular database.

4. The method according to claim 1, wherein the data retrieval node comprises a Herefile node for placing data into a graph.

5. The method according to claim 3, wherein the querydump node includes information for identifying the database and query terms for performing a query on the database.

6. The method according to claim 5, wherein the querydump node further includes information for accessing the database.

7. The method according to claim 1, further comprising executing one or more nodes of the graph-space.

8. The method according to claim 1, further comprising executing the graph-space of the workspace according to the sequence dependency.

9. The method according to claim 8, further comprising color-coding the one or more nodes according to a status of the execution of respective node.

10. The method according to claim 9, wherein the status of the node comprises unprocessed, processing, successfully processed and failed processing indicators.

11. The method according to claim 8, further comprising displaying results of the graph-space execution.

12. The method according to claim 1, further comprising creating a composite node for the graph-space, wherein the composite node represents a grouping at least a pair of the plurality of nodes.

13. The method according to claim 1, further comprising setting one or more parameters of one or more of the plurality of nodes.

14. The method according to claim 1, wherein establishing logic comprises including one or more expressions, statements, and/or operators.

15. The method according to claim 14, wherein the statements may be selected from the group consisting of: variable related statements, output related statements, database related statements, procedural statements.

16. The method according to claim 14, wherein the operators may be selected from the group consisting of numerical operators, logical operators, comparison operators, conditional operators, null operators, string operators, date and/or time operators, and list operators.

17. A computer readable media having computer instructions for enabling a computer system to perform a method for validating data using a graphical user interface of a computer system, the method comprising:
defining one or more parameters of a graph-space;
arranging a plurality of nodes in a graph-space, wherein each node represents at least one processing step to be performed to validate data and wherein at least one of the plurality of nodes comprise at least one data retrieval node for retrieving data for validation;
establishing at least one output from each of the plurality of nodes;
except for the at least one data retrieval node, establishing at least one input from each of the plurality of nodes;
configuring one or more parameters of each node;
linking at least one output of each of substantially all of the plurality of nodes with an input of another node;
sequencing a dependency among the plurality of nodes; and
establishing processing logic in at least one of the plurality of nodes to process data.

18. The media according to claim 17, wherein the data retrieval node comprises an infile node which retrieves data from a particular data file.

19. The media according to claim 17, wherein the data retrieval node comprises a querydump node for retrieving data from a query of a particular database.

20. The media according to claim 1, wherein the data retrieval node comprises a Herefile node for placing data into a graph.

21. The media according to claim 19, wherein the querydump node includes information for identifying the database and query terms for performing a query on the database.

22. The media according to claim 21, wherein the querydump node further includes information for accessing the database.

23. The media according to claim 17, further comprising executing one or more nodes of the graph-space.

24. The media according to claim 17, wherein the method further comprises executing the graph-space of the workspace according to the sequence dependency.

25. The media according to claim 24, wherein the method further comprises color-coding the one or more nodes according to a status of the execution of respective node.

26. The media according to claim 25, wherein the status of the node comprises unprocessed, processing, successfully processed and failed processing.

27. The media according to claim 24, wherein the method further comprises displaying results of the graph-space execution.

28. The media according to claim 17, further comprising creating a composite node for the graph-space, wherein the composite node represents a grouping at least a pair of the plurality of nodes.

29. The media according to claim 17, wherein the method further comprises setting one or more parameters of one or more of the plurality of nodes.

30. The media according to claim 17, wherein the method further comprises setting one or more expressions, statements, and/or operators for one or more nodes.

31. A system for processing data using a graphical user interface of a computer system comprising:
arranging means for arranging a plurality of nodes in a graph-space, wherein each node represents at least one processing step for processing data and wherein at least one of the plurality of nodes comprise at least one data retrieval node for retrieving data for validation;
establishing means for establishing at least one output from substantially all of the plurality of nodes and for establishing at least one input to each of the plurality of nodes, except for the at least one data retrieval node;
configuring means for configuring one or more parameters of each node;
linking means for linking at least one output of each of substantially all of the plurality of nodes with an input of another node, each link representing a data flow;
sequencing means for sequencing execution of one or more nodes; and
setup means for setting up processing logic in at least one node to process data in a predetermined manner.

32. A system for processing data using a graphical user interface of a computer system comprising:
an editor including a graphical user interface;
a graphical workspace for designing a processing graph having a plurality of processing nodes;
an execution file, wherein the execution file results from compiling the processing graph; and
a controller for directing the running of the execution file on one or more computers.

33. The system according to claim 32, wherein the one or more computers comprises a server farm.

34. The system according to claim 33, wherein the server farm includes one or more drones each for operating a process of one or more nodes.

35. An application program having computer instructions for enabling a computer system to perform a method for validating data using a graphical user interface of a computer system, the method comprising:
defining one or more parameters of a graph-space;
arranging a plurality of nodes in a graph-space, wherein each node represents at least one processing step to be performed to validate data and wherein at least one of the plurality of nodes comprise at least one data retrieval node for retrieving data for validation;
establishing at least one output from each of the plurality of nodes;
except for the at least one data retrieval node, establishing at least one input from each of the plurality of nodes;
configuring one or more parameters of each node;
linking at least one output of each of substantially all of the plurality of nodes with an input of another node;
sequencing a dependency among the plurality of nodes; and
establishing processing logic in at least one of the plurality of nodes to process data.
